(19) United States
(12) Patent Application Publication
(10) Pub. No.: US 2022/0345630 A1
(43) Pub. Date: Oct. 27, 2022

(54) INFORMATION PROCESSING APPARATUS, INFORMATION PROCESSING METHOD, PROGRAM, AND INFORMATION PROCESSING SYSTEM

(71) Applicant: Sony Group Corporation, Tokyo (JP)

(72) Inventor: Yoshitaka MIYATANI, Kanagawa (JP)

(73) Assignee: Sony Group Corporation, Tokyo (JP)

(21) Appl. No.: 17/762,369

(22) PCT Filed: Oct. 15, 2020
(86) PCT No.: PCT/JP2020/038857

§ 371 Date: Mar. 22, 2022

(30) Foreign Application Priority Data
Oct. 29, 2019 (JP) 2019-196352

(51) Int. Cl. H04N 5/232; G06V 20/58

(52) U.S. Cl. CPC H04N 5/23296; H04N 5/23218; G06V 20/58; B60Q 9/00

(57) ABSTRACT

An information processing apparatus includes: a pixel selection unit configured to select a pixel to be used from among pixels having a plurality of angles of view, on the basis of information obtained from a detection signal of an imaging element including a plurality of pixels, in which the imaging element is configured to receive incident light incident from a subject without via either an imaging lens or a pinhole and to output the detection signal, and the detection signal indicates an output pixel value that is modulated in accordance with an incident angle of the incident light and corresponds to any of the plurality of angles of view; and a control unit configured to execute a predetermined process by using a selected pixel. The present technology can be applied to, for example, an in-vehicle system.

### TECHNICAL FIELD

The present technology relates to an information processing apparatus, an information processing method, a program, and an information processing system, and particularly relates to an information processing apparatus, an information processing method, a program, and an information processing system that use a lensless camera.

### BACKGROUND ART

Conventionally, it has been proposed to perform shake correction by calculating a zoom magnification on the basis of a speed of a mobile object, a relative distance of an object with respect to the mobile object, and a delay time of a zoom operation, driving a zoom lens to achieve the calculated zoom magnification, and setting a position of the object at a correction center (see, for example, Patent Document 1).

### CITATION LIST

### Patent Document

Patent Document 1: Japanese Patent Application Laid-open No. 2015-195569

### SUMMARY OF THE INVENTION

### Problems to be Solved by the Invention

In this way, in a case of capturing an image of surroundings from a mobile object, it takes time to drive a zoom lens. Therefore, it has been necessary to perform complicated control in consideration of a speed and the like of the mobile object in order to obtain an image having an appropriate angle of view.

The present technology has been made in view of such a situation, and an object is to enable to easily obtain an image of a suitable angle of view.

### Solutions to Problems

An information processing apparatus of a first aspect of the present technology includes: a pixel selection unit configured to select a pixel to be used from among pixels having a plurality of angles of view, on the basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and a control unit configured to execute a predetermined process by using a selected pixel.

In an information processing method of the first aspect of the present technology, an information processing apparatus performs processing including: selecting a pixel to be used from among pixels having a plurality of angles of view, on the basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and executing a predetermined process by using a selected pixel.

A program of the first aspect of the present technology performs processing including: selecting a pixel to be used from among pixels having a plurality of angles of view, on the basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and executing a predetermined process by using a selected pixel.

An information processing system of a second aspect of the present technology includes: an imaging element including a plurality of pixels, the imaging element being configured to receive incident light incident from a subject without via either an imaging lens or a pinhole and to output a detection signal, the detection signal indicating an output pixel value that is modulated in accordance with an incident angle of the incident light and corresponding to any of a plurality of angles of view; and an information processing apparatus, in which the information processing apparatus includes: a pixel selection unit configured to select a pixel to be used from among pixels having the plurality of angles of view on the basis of information obtained from the detection signal; and a control unit configured to execute a predetermined process by using a selected pixel.

In the first aspect or the second aspect of the present technology, a pixel to be used is selected from among the pixels having a plurality of angles of view, on the basis of information obtained from a detection signal of the imaging element including the plurality of pixels, the imaging element is configured to receive incident light incident from a subject without via either an imaging lens or a pinhole and to output the detection signal, the detection signal indicates an output pixel value modulated in accordance with an incident angle of the incident light and corresponds to any of the plurality of angles of view, and a predetermined process is executed using a selected pixel.

### BRIEF DESCRIPTION OF DRAWINGS

FIG. 1 is a block diagram illustrating a configuration example of an information processing system to which the present technology is applied.

FIG. 2 is a block diagram illustrating a configuration example of an imaging unit of the information processing system of FIG. 1.

FIG. 3 is a view for explaining a principle of imaging in an imaging element of FIG. 2.

FIG. 4 is a view illustrating a configuration example of a pixel array unit of the imaging element of FIG. 2.

FIG. 5 is a view for explaining a first configuration example of the imaging element of FIG. 2.

FIG. 6 is a view for explaining a second configuration example of the imaging element of FIG. 2.

FIG. 7 is a view for explaining a principle of occurrence of incident angle directivity.

FIG. 8 is a view for explaining a change in incident angle directivity by using an on-chip lens.

FIG. 9 is a view for explaining a relationship between a narrow angle-of-view pixel and a wide angle-of-view pixel.

FIG. 10 is a view for explaining a relationship between a narrow angle-of-view pixel and a wide angle-of-view pixel.

FIG. 11 is a view for explaining a relationship between a narrow angle-of-view pixel and a wide angle-of-view pixel.

FIG. 12 is a view for explaining a difference in image quality between a narrow angle-of-view pixel and a wide angle-of-view pixel.

FIG. 13 is a view for explaining a difference in image quality between a narrow angle-of-view pixel and a wide angle-of-view pixel.

FIG. 14 is a view for explaining an example of combining pixels having a plurality of angles of view.

FIG. 15 is a block diagram illustrating a configuration example of a control unit in FIG. 1.

FIG. 16 is a flowchart for explaining a first embodiment of a monitoring process.

FIG. 17 is a flowchart for explaining details of an image restoration process.

FIG. 18 is a view for explaining an optical axis deviation of a zoom lens camera.

FIG. 19 is a view illustrating an example of an angle of view of the imaging element.

FIG. 20 is a view illustrating an example of an opening setting range of the imaging element.

FIG. 21 is a view illustrating an example of a light-shielding pattern of a wide angle-of-view pixel.

FIG. 22 is a view illustrating an example of a light-shielding pattern of a narrow angle-of-view pixel.

FIG. 23 is a view illustrating an arrangement example of pixels in a pixel array unit.

FIG. 24 is a view illustrating an arrangement example of pixels in a pixel array unit.

FIG. 25 is a flowchart for explaining the first embodiment of the monitoring process.

FIG. 26 is a view for explaining a pixel selection method.

FIG. 27 is a view for explaining a pixel selection method.

FIG. 28 is a view illustrating a modified example of the imaging element.

FIG. 29 is a view illustrating a modified example of the imaging element.

FIG. 30 is a view illustrating a modified example of the imaging element.

FIG. 31 is a view illustrating a modified example of the imaging element.

FIG. 32 is a view illustrating a modified example of the imaging element.

### MODE FOR CARRYING OUT THE INVENTION

Hereinafter, preferred embodiments of the present technology will be described in detail with reference to the accompanying drawings. Note that, in the present specification and the drawings, components having substantially the same functional configuration are denoted by the same reference numerals, and redundant explanations are omitted as needed.

Furthermore, the description will be given in the following order.

1. First Embodiment

2. Second Embodiment

3. Modified example

4. Other

### 1. First Embodiment

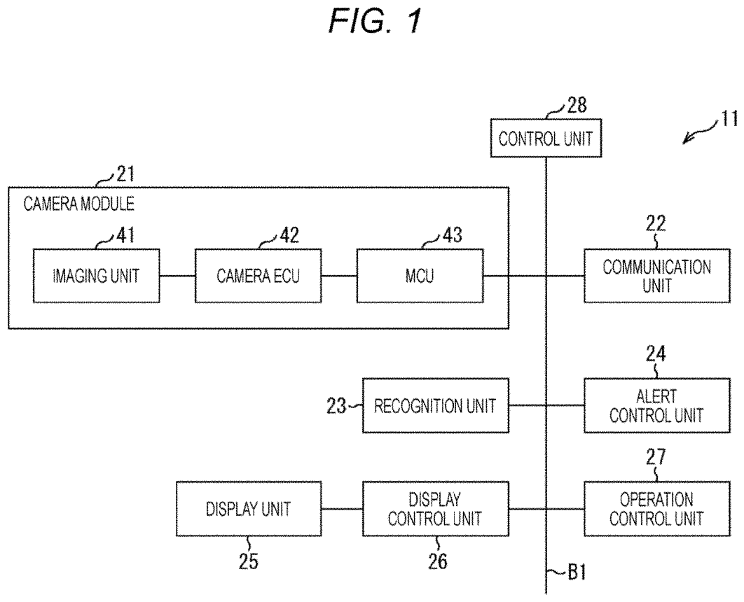

First, a first embodiment of the present technology will be described with reference to FIGS. 1 to 18.

<Configuration Example of Information Processing System 11>

FIG. 1 is a block diagram illustrating a configuration example of an information processing system 11 to which the present technology is applied.

The information processing system 11 is a system that is provided in a vehicle and performs control and the like of the vehicle.

The information processing system 11 includes a camera module 21, a communication unit 22, a recognition unit 23, an alert control unit 24, a display unit 25, a display control unit 26, an operation control unit 27, and a control unit 28. The camera module 21, the communication unit 22, the recognition unit 23, the alert control unit 24, the display control unit 26, the operation control unit 27, and the control unit 28 are connected to each other via a bus B1.

Note that, in the following, for the sake of simplicity of the description, the description of the bus B1 in a case where each unit of the information processing system 11 performs data exchange and the like via the bus B1 will be omitted. For example, in a case where the control unit 28 supplies data to the communication unit 22 via the bus B1, it is simply described that the control unit 28 supplies the data to the communication unit 22.

The camera module 21 captures an image of the front of the vehicle. The camera module 21 includes an imaging unit 41, a camera ECU 42, and a micro control unit (MCU) 43.

As will be described later, the imaging unit 41 includes a lenz less camera (LLC) that does not use an imaging lens or a pinhole. The imaging unit 41 can simultaneously capture an image of the front of the vehicle with a plurality of angles of view. The imaging unit 41 supplies obtained detection images of the plurality of angles of view to the camera ECU 42.

The camera ECU 42 performs predetermined image processing on a detection image of each angle of view, and supplies the detection image of each angle of view to the MCU 43.

The MCU 43 converts data supplied from the camera ECU 42 (for example, the detection image) into data in a format for communication, and outputs to the bus B1. Furthermore, the MCU 43 converts data received from the bus B1 into data in a format for the camera ECU 42, and supplies to the camera ECU 42.

The communication unit 22 transmits and receives information to and from surrounding vehicles, portable terminal devices owned by pedestrians, roadside units, and external servers, for example, through various types of wireless communication such as vehicle-to-vehicle communication, vehicle-to-pedestrian communication, and road-to-vehicle communication.

The recognition unit 23 performs a recognition process of an object in front of the vehicle on the basis of a restored image that is restored from a detection image by the control unit 28. For example, the recognition unit 23 performs the recognition process for a position, a size, a type, a movement, and the like of the object. The recognition unit 23 outputs data indicating a recognition result of the object, to the bus B1.

Note that, as will be described later, the detection image is an image in which an image of a subject is not detected and the subject cannot be visually recognized, while the restored image is an image restored from the detection image to a state where the subject is visible.

The alert control unit 24 performs a process of superimposing a warning display that calls attention to a hazardous object on the restored image, on the basis of a detection result of a hazardous object in front of the vehicle by the control unit 28. The alert control unit 24 outputs the restored image on which the warning display is superimposed, to the bus B1. Note that, in a case where a hazardous object has not been detected, the alert control unit 24 outputs the restored image to the bus B1 as it is without superimposing the warning display.

The display unit 25 includes, for example, a display such as an organic EL display or a liquid crystal display, and displays the restored image and the like. The display unit 25 is installed, for example, at a position visible to a driver, for example, on a dashboard, in an instrument panel, or the like of the vehicle.

The display control unit 26 controls a display process by the display unit 25. For example, the display control unit 26 controls displaying of the restored image by the display unit 25. Furthermore, for example, the display control unit 26 controls displaying of the warning display by controlling the displaying of the restored image on which the warning display is superimposed by the display unit 25.

The operation control unit 27 controls operation of the vehicle. For example, the operation control unit 27 controls a speed, a traveling direction, a brake, and the like of the vehicle so as to avoid hazardous objects detected by the control unit 28.

The control unit 28 includes, for example, various processors, controls each unit of the information processing system 11, and executes various processes. For example, the control unit 28 detects a hazardous object that may possibly collide or contact with the vehicle, from among objects recognized by the recognition unit 23. Furthermore, the control unit 28 selects a detection image to be used from among detection images of individual angles of view generated by the camera module 21, on the basis of a detection result of the hazardous object. The control unit 28 restores a restored image in which an image of a subject is formed from the selected detection image, and outputs the restored image to the bus B1.

<Configuration Example of Imaging Unit 41>

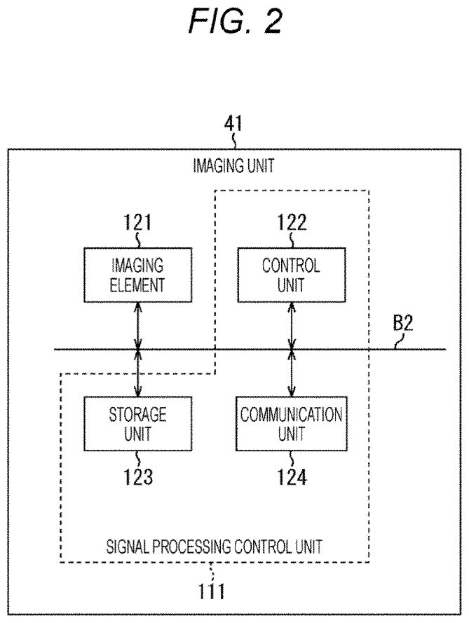

FIG. 2 is a block diagram illustrating a configuration example of the imaging unit 41 of the camera module 21.

The imaging unit 41 includes an imaging element 121, a control unit 122, a storage unit 123, and a communication unit 124. Furthermore, the control unit 122, the storage unit 123, and the communication unit 124 constitute a signal processing control unit 111 that performs signal processing, control of the imaging unit 41, and the like. Note that the imaging unit 41 does not include an imaging lens (imaging-lens free).

Furthermore, the imaging element 121, the control unit 122, the storage unit 123, and the communication unit 124 are connected to each other via a bus B2, and perform transmission, reception, and the like of data via the bus B2.

Note that, in the following, for the sake of simplicity of the description, the description of the bus B2 in a case where each unit of the imaging unit 41 performs data exchange and the like via the bus B2 will be omitted. For example, in a case where the communication unit 124 supplies data to the control unit 122 via the bus B2, it is simply described that the communication unit 124 supplies the data to the control unit 122.

The imaging element 121 is an imaging element in which detection sensitivity of each pixel has incident angle directivity, and the imaging element 121 outputs, to the bus B2, an image including a detection signal indicating a detection signal level according to an amount of incident light. The detection sensitivity of each pixel having incident angle directivity means that light-receiving sensitivity characteristics according to an incident angle of incident light on each pixel are made different for each pixel. However, the light-receiving sensitivity characteristics of all the pixels do not have to be completely different, and the light-receiving sensitivity characteristics of some pixels may be the same.

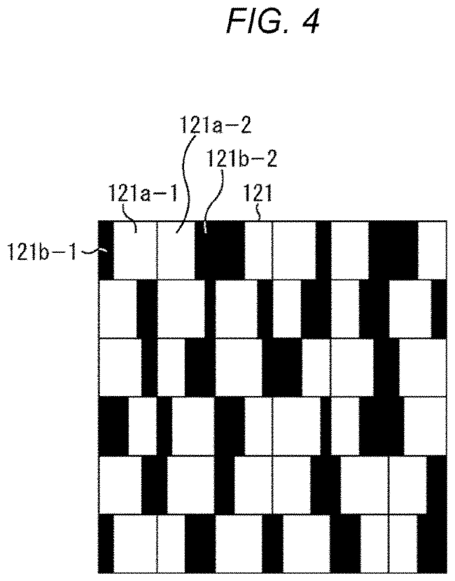

More specifically, the imaging element 121 may have a basic structure similar to that including a general imaging element such as, for example, a complementary metal oxide semiconductor (CMOS) image sensor. However, the imaging element 121 has a different configuration of each pixel constituting a pixel array unit from that of a general one, and has a configuration in which incident angle directivity is given, for example, as will be described later with reference to FIGS. 4 to 6. Then, the imaging element 121 has different (changed) light-receiving sensitivity depending on an incident angle of incident light for each pixel, and has incident angle directivity with respect to the incident angle of the incident light on a pixel basis.

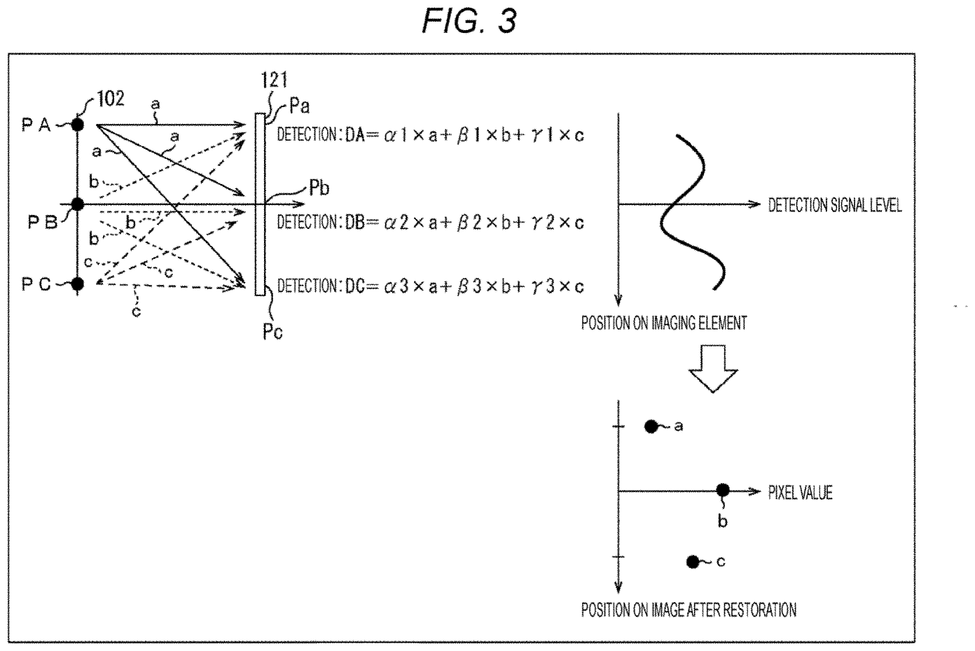

Here, for example, it is assumed that all subjects are a set of point light sources, and light is emitted from individual point light sources in all directions. For example, it is assumed that a subject surface 102 of a subject in the upper left of FIG. 3 includes point light sources PA to PC, and each of the point light sources PA to PC emits a plurality of light beams having light intensities a to c to the surroundings. Furthermore, hereinafter, it is assumed that the imaging element 121 includes, at positions Pa to Pc, pixels (hereinafter, referred to as pixels Pa to Pc) having incident angle directivity that is individually different.

In this case, as illustrated in the upper left of FIG. 3, light beams having the same light intensity emitted from the same point light source are incident on individual pixels of the imaging element 121. For example, light beams with the light intensity a emitted from the point light source PA are individually incident on the pixels Pa to Pc of the imaging element 121. Whereas, the light beams emitted from the same point light source are incident at individually different incident angles for the individual pixels. For example, the light beams from the point light source PA are incident on the pixels Pa to Pc at individually different incident angles.

On the other hand, since the incident angle directivity is individually different in the pixels Pa to Pc, the light beams of the same light intensity emitted from the same point light source are detected in the individual pixels with different sensitivity. As a result, the light beams having the same light intensity are detected with different detection signal levels for the individual pixels. For example, detection signal levels for light beams having the light intensity a from the point light source PA are to be an individually different values for the pixel Pa to pixel Pc.

Then, a light-receiving sensitivity level of each pixel with respect to a light beam from each point light source is obtained by multiplying a light intensity of the light beam by a coefficient indicating light-receiving sensitivity (that is, incident angle directivity) with respect to an incident angle of the light beam. For example, a detection signal level of the pixel Pa with respect to a light beam from the point light source PA is obtained by multiplying the light intensity a of the light beam of the point light source PA by a coefficient indicating incident angle directivity of the pixel Pa with respect to an incident angle of the light beam on the pixel Pa.

Therefore, detection signal levels DA, DB, and DC of the pixels Pc, Pb, and Pa are represented by the following Equations (1) to (3), respectively.

DA=α1×a+β1×b+γ1×c (1)

DB=α2×a+β2×b+γ2×c (2)

DC=α3×a+β3×b+γ3×c (3)

Here, the coefficient α1 is a coefficient indicating incident angle directivity of the pixel Pc with respect to an incident angle of a light beam from the point light source PA to the pixel Pc, and is set in accordance with the incident angle. Furthermore, α1×a indicates a detection signal level of the pixel Pc with respect to a light beam from the point light source PA.

The coefficient β1 is a coefficient indicating incident angle directivity of the pixel Pc with respect to an incident angle of a light beam from the point light source PB to the pixel Pc, and is set in accordance with the incident angle. Furthermore, β1×b indicates a detection signal level of the pixel Pc with respect to a light beam from the point light source PB.

The coefficient γ1 is a coefficient indicating incident angle directivity of the pixel Pc with respect to an incident angle of a light beam from the point light source PC to the pixel Pc, and is set in accordance with the incident angle. Furthermore, γ1×c indicates a detection signal level of the pixel Pc with respect to a light beam from the point light source PC.

In this way, the detection signal level DA of the pixel Pa is obtained by a product-sum of: the individual light intensities a, b, and c of light beams in the pixel Pc from the point light sources PA, PB, and PC; and the coefficients α1, β1, and γ1 indicating incident angle directivity according to each incident angle.

Similarly, as shown in Equation (2), the detection signal level DB of the pixel Pb is obtained by a product-sum of: the individual light intensities a, b, and c of light beams in the pixel Pb from the point light sources PA, PB, and PC; and the coefficients α2, β2, and γ2 indicating incident angle directivity according to each incident angle. Furthermore, as shown in Equation (3), the detection signal level DC of the pixel Pc is obtained by a product-sum of: the individual light intensities a, b, and c of light beams in the pixel Pa from the point light sources PA, PB, and PC; and the coefficients α2, β2, and γ2 indicating incident angle directivity according to each incident angle.

However, in the detection signal levels DA, DB, and DC of the pixels Pa, Pb, and Pc, the light intensities a, b, and c of light beams respectively emitted from the point light sources PA, PB, and PC are mixed, as shown in Equations (1) to (3). Therefore, as illustrated in the upper right of FIG. 3, the detection signal level in the imaging element 121 is different from the light intensity of each point light source on the subject surface 102. Therefore, an image obtained by the imaging element 121 is different from an image on which an image of the subject surface 102 is formed.

Whereas, by creating simultaneous equations including Equations (1) to (3) and solving the created simultaneous equations, the light intensities a to c of the light beams of individual point light sources PA to PC are obtained. Then, by arranging pixels having pixel values according to the obtained light intensities a to c in accordance with an arrangement (a relative position) of the point light sources PA to PC, a restored image in which an image of the subject surface 102 is formed is restored as illustrated in the lower right of FIG. 3.

In this way, it is possible to implement the imaging element 121 having incident angle directivity in each pixel, without the need for an imaging lens and a pinhole.

Hereinafter, a collection of coefficients (for example, the coefficients α1, β1, and γ1) for each equation constituting the simultaneous equations is referred to as a coefficient set. Hereinafter, a collection of a plurality of coefficient sets (for example, a coefficient set α1, β1, γ1, a coefficient set α2, β2, γ2, and a coefficient set α3, β3, γ3) corresponding to a plurality of equations included in the simultaneous equations is referred to as a coefficient set group.

Here, when a subject distance from the subject surface 102 to a light-receiving surface of the imaging element 121 is different, incident angles of light beams on the imaging element 121 from the individual point light sources on the subject surface 102 are different. Therefore, different coefficient set groups are required for each subject distance.

Therefore, in the control unit 28, by preparing a coefficient set group for each distance (subject distance) from the imaging element 121 to the subject surface in advance, creating simultaneous equations by switching the coefficient set group for each subject distance, and solving the created simultaneous equations, it is possible to obtain a restored image of a subject surface having various subject distances on the basis of one detection image. For example, by capturing a detection image once and recording, and then using the recorded detection image and switching the coefficient set group in accordance with a distance to the subject surface to restore the restored image, it is possible to generate a restored image of the subject surface at any subject distance.

Furthermore, even for the subject surface 102 having the same subject distance, incident angles of light beams on the imaging element 121 from individual point light sources are different if the number and arrangement of the point light sources to be set are different. Therefore, a plurality of coefficient set groups may be required for the subject surface 102 having the same subject distance. Moreover, the incident angle directivity of each pixel 121a needs to be set so as to ensure independence of the simultaneous equations described above.

Furthermore, since an image outputted by the imaging element 121 is an image including a detection signal and in which an image of the subject is not formed as illustrated in the upper right of FIG. 3, the subject cannot be visually recognized. That is, a detection image including a detection signal outputted by the imaging element 121 is a set of pixel signals, but is an image in which the subject cannot be recognized (the subject is not visible) even if the user visually observes.

Therefore, hereinafter, as illustrated in the upper right of FIG. 3, an image including a detection signal and in which an image of the subject is not formed, that is, an image captured by the imaging element 121 is referred to as a detection image.

Note that the incident angle directivity does not necessarily have to be all different on a pixel basis, and pixels having the same incident angle directivity may be included.

Returning to FIG. 2, the control unit 122 includes, for example, various processors, controls each unit of the imaging unit 41, and executes various processes.

The storage unit 123 includes one or more storage devices such as a read only memory (ROM), a random access memory (RAN), and a flash memory, and stores, for example, a program, data, and the like used for processing of the imaging unit 41.

The communication unit 124 communicates with the camera ECU 42 by a predetermined communication method.

<First Configuration Example of Imaging Element 121>

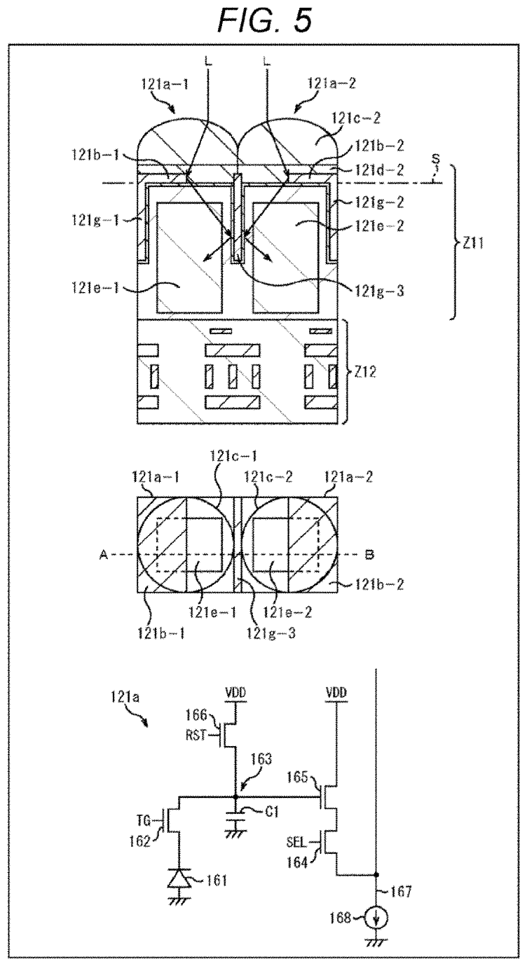

Next, a first configuration example of the imaging element 121 of the imaging unit 41 of FIG. 2 will be described with reference to FIGS. 4 and 5.

FIG. 4 illustrates a front view of a part of the pixel array unit of the imaging element 121. Note that FIG. 4 illustrates an example of a case where the number of pixels in the pixel array unit is 6 vertical pixels×6 horizontal pixels, but the number of pixels in the pixel array unit is not limited to this. Furthermore, a configuration example of the pixel array unit in FIG. 4 is for explaining the first configuration example of the imaging element 121, and a configuration example of an actual pixel array unit will be described later.

In the imaging element 121 of FIG. 4, a light-shielding film 121b, which is one of modulation elements, is provided for each pixel 121a so as to cover a part of a light-receiving region (a light-receiving surface) of a photodiode of the pixel 121a, and incident light incident on each pixel 121a is optically modulated in accordance with an incident angle. Then, for example, by providing the light-shielding film 121b in a different range for each pixel 121a, light-receiving sensitivity for the incident angle of the incident light is different for each pixel 121a, and each pixel 121a is to have different incident angle directivity.

For example, in a pixel 121a-1 and a pixel 121a-2, a range of light shielding in the light-receiving region of the photodiode is different depending on a provided light-shielding film 121b-1 and light-shielding film 121b-2 (at least any of a light-shielding region (position) and a light-shielding area is different). That is, in the pixel 121a-1, the light-shielding film 121b-1 is provided so as to shield light by a predetermined width on a part of a left side of the light-receiving region of the photodiode. Whereas, in the pixel 121a-2, the light-shielding film 121b-2 is provided so as to shield light by a predetermined width on a part of a right side of the light-receiving region. Note that the width to be light-shielded by the light-shielding film 121b-1 in the light-receiving region of the photodiode and the width to be light-shielded by the light-shielding film 121b-2 in the light-receiving region of the photodiode may be different or the same. Similarly, in other pixels 121a, the light-shielding film 121b is randomly arranged in the pixel array unit so as to shield a different range of the light-receiving region for each pixel.

An upper stage of FIG. 5 is a side cross-sectional view of the first configuration example of the imaging element 121, and a middle stage of FIG. 5 is a top view of the first configuration example of the imaging element 121. Furthermore, the side cross-sectional view of the upper stage of FIG. 5 is an AB cross section in the middle stage of FIG. 5. Moreover, a lower stage of FIG. 5 is an example of a circuit configuration of the imaging element 121.

In the imaging element 121 in the upper stage of FIG. 5, incident light is incident from the upper side to the lower side in the figure. The adjacent pixels 121a-1 and 121a-2 are of a so-called back-illuminated type in which a wiring layer Z12 is provided at a bottom layer in the figure, and a photoelectric conversion layer Z11 is provided above the wiring layer Z12.

Note that, hereinafter, in a case where it is not necessary to distinguish the pixels 121a-1 and 121a-2, a description of a number at the end of the reference numeral is omitted, and the reference is simply made as the pixel 121a. Hereinafter, in the specification, numbers and alphabets at the end of reference numerals may be similarly omitted for other configurations as well.

Furthermore, FIG. 5 illustrates only the side view and the top view for two pixels constituting the pixel array unit of the imaging element 121, and it goes without saying that a larger number of pixels 121a are arranged, but the illustration is omitted.

Moreover, the pixels 121a-1 and 121a-2 are respectively provided with photodiodes 121e-1 and 121e-2 as photoelectric conversion elements in the photoelectric conversion layers Z11. Furthermore, on the photodiodes 121e-1 and 121e-2, on-chip lenses 121c-1 and 121c-2 and color filters 121d-1 and 121d-2 are respectively laminated from above.

The on-chip lenses 121c-1 and 121c-2 collect incident light on the photodiodes 121e-1 and 121e-2.

The color filters 121d-1 and 121d-2 are optical filters that transmit light of specific wavelengths such as, for example, red, green, blue, infrared, and white. Note that, in a case of white, the color filters 121d-1 and 121d-2 may be transparent filters, or may be omitted.

In the photoelectric conversion layers Z11 of the pixels 121a-1 and 121a-2, light-shielding films 121g-1 to 121g-3 are individually formed at boundaries between the pixels, to suppress incident light L from being incident on an adjacent pixel and causing crosstalk, for example, as illustrated in FIG. 5.

Furthermore, as illustrated in the upper and middle stages of FIG. 5, the light-shielding films 121b-1 and 121b-2 shield a part of a light-receiving surface S when viewed from an upper surface. On the light-receiving surface S of the photodiodes 121e-1 and 121e-2 in pixels 121a-1 and 121a-2, different ranges are respectively shielded by the light-shielding films 121b-1 and 121b-2, which causes different incident angle directivity to be set independently for each pixel. However, the light-shielding range does not need to be different for all the pixels 121a of the imaging element 121, and there may be some pixels 121a in which the same range is light-shielded.

Note that, as illustrated in the upper stage of FIG. 5, the light-shielding film 121b-1 and the light-shielding film 121g-1 are connected to each other and are formed in an L-shape when viewed from a side surface. Similarly, the light-shielding film 121b-2 and the light-shielding film 121g-2 are connected to each other and are formed in an L-shape when viewed from a side surface. Furthermore, the light-shielding film 121b-1, the light-shielding film 121b-2, and the light-shielding film 121g-1 to 121g-3 include metal, and include, for example, tungsten (W), aluminum (Al), or an alloy of Al and copper (Cu). Furthermore, the light-shielding film 121b-1, the light-shielding film 121b-2, and the light-shielding film 121g-1 to 121g-3 may be simultaneously formed using the same metal as wiring, in the same process as a process in which the wiring is formed in a semiconductor process. Note that film thicknesses of the light-shielding film 121b-1, the light-shielding film 121b-2, and the light-shielding film 121g-1 to 121g-3 do not need to be the same depending on a position.

Furthermore, as illustrated in the lower stage of FIG. 5, the pixel 121a includes a photodiode 161 (corresponding to a photodiode 121e), a transfer transistor 162, a floating diffusion (FD) unit 163, a selection transistor 164, an amplification transistor 165, and a reset transistor 166, and is connected to a current source 168 via a vertical signal line 167.

In the photodiode 161, an anode electrode is grounded, and a cathode electrode is connected to a gate electrode of the amplification transistor 165 via the transfer transistor 162.

The transfer transistor 162 is driven in accordance with a transfer signal TG. For example, when the transfer signal TG supplied to a gate electrode of the transfer transistor 162 reaches a high level, the transfer transistor 162 is turned on. As a result, electric charges stored in the photodiode 161 are transferred to the FD unit 163 via the transfer transistor 162.

The FD unit 163 is a floating diffusion region having a charge capacitance Cl and provided between the transfer transistor 162 and the amplification transistor 165, and temporarily stores an electric charge transferred from the photodiode 161 via the transfer transistor 162. The FD unit 163 is a charge detection unit configured to convert an electric charge into a voltage, and electric charges stored in the FD unit 163 are converted into a voltage by the amplification transistor 165.

The selection transistor 164 is driven in accordance with a selection signal SEL and is turned on when the selection signal SEL supplied to a gate electrode reaches a high level, to connect the amplification transistor 165 and the vertical signal line 167.

The amplification transistor 165 serves as an input unit for a source follower, which is a read circuit configured to read out a signal obtained by photoelectric conversion in the photodiode 161, and outputs a detection signal (a pixel signal) at a level corresponding to electric charges stored in the FD unit 163, to the vertical signal line 167. That is, by a drain terminal being connected to a power supply VDD, and a source terminal being connected to the vertical signal line 167 via the selection transistor 164, the amplification transistor 165 constitutes a source follower with the current source 168 connected to one end of the vertical signal line 167. A value of this detection signal (an output pixel value) is modulated in accordance with an incident angle of incident light from the subject, and has different characteristics (directivity) (has incident angle directivity) depending on the incident angle.

The reset transistor 166 is driven in accordance with a reset signal RST. For example, the reset transistor 166 is turned on when the reset signal RST supplied to a gate electrode reaches a high level, and discharges an electric charge accumulated in the FD unit 163 to the power supply VDD, to reset the FD unit 163.

Note that a shape of the light-shielding film 121b of each pixel 121a is not limited to the example of FIG. 4, and can be set to any shape. For example, it is possible to adopt a shape extending in a horizontal direction in FIG. 4, an L-shaped shape extending in a vertical direction and the horizontal direction, a shape provided with a rectangular opening, and the like.

<Second Configuration Example of Imaging Element 121>

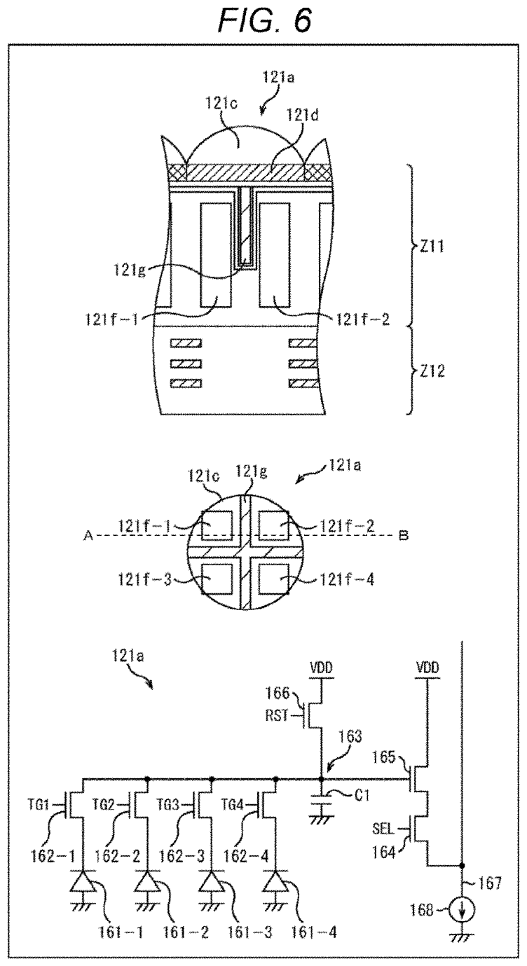

FIG. 6 is a view illustrating a second configuration example of the imaging element 121. An upper stage of FIG. 6 illustrates a side cross-sectional view of the pixel 121a of the imaging element 121, which is a second configuration example, and a middle stage of FIG. 6 illustrates a top view of the imaging element 121. Furthermore, the side cross-sectional view of the upper stage of FIG. 6 is an AB cross section in the middle stage of FIG. 6. Moreover, a lower stage of FIG. 6 is an example of a circuit configuration of the imaging element 121.

The imaging element 121 in FIG. 6 has a configuration different from that of the imaging element 121 illustrated in FIG. 5 in that four photodiodes 121f-1 to 121f-4 are formed in one pixel 121a, and a light-shielding film 121g is formed in a region that separates photodiodes 121f-1 to 121f-4. That is, in the imaging element 121 of FIG. 6, the light-shielding film 121g is formed in a “+” shape when viewed from an upper surface. Note that common configurations of these are designated by the same reference numerals as those in FIG. 5, and detailed description thereof will be omitted.

In the imaging element 121 of FIG. 6, the photodiodes 121f-1 to 121f-4 are separated by the light-shielding film 121g, which prevents generation of electrical and optical crosstalk between the photodiodes 121f-1 to 121f-4. That is, the light-shielding film 121g in FIG. 6 is for preventing crosstalk similarly to the light-shielding film 121g of the imaging element 121 in FIG. 5, and is not for providing incident angle directivity.

Furthermore, in the imaging element 121 of FIG. 6, one FD unit 163 is shared by the four photodiodes 121f-1 to 121f-4. The lower stage of FIG. 6 illustrates an example of a circuit configuration in which one FD unit 163 is shared by the four photodiodes 121f-1 to 121f-4. Note that, in the lower stage of FIG. 6, the description of the same configurations as those of the lower stage of FIG. 5 will be omitted.

A difference in the lower stage of FIG. 6 from the circuit configuration of the lower stage of FIG. 5 is that photodiodes 161-1 to 161-4 (corresponding to the photodiodes 121f-1 to 121f-4 in the upper stage of FIG. 6) and transfer transistors 162-1 to 162-4 are provided instead of the photodiode 161 (corresponding to the photodiode 121e in the upper stage of FIG. 5) and the transfer transistor 162, and the FD unit 163 is shared.

With such a configuration, electric charges accumulated in the photodiodes 121f-1 to 121f-4 are transferred to the common FD unit 163 that has a predetermined capacitance and is provided at a connection part between a gate electrode of an amplification transistor 165 and the photodiodes 121f-1 to 121f-4. Then, a signal corresponding to a level of the electric charges held in the FD unit 163 is read out as a detection signal (a pixel signal).

Therefore, the electric charges accumulated in the photodiodes 121f-1 to 121f-4 can be selectively contributed to output of the pixel 121a, that is, the detection signal, in various combinations. That is, different incident angle directivity can be obtained by having a configuration in which electric charges can be read out independently for each of the photodiodes 121f-1 to 121f-4, and making a mutual difference in the photodiodes 121f-1 to 121f-4 that contribute to the output (in a degree of contribution by the photodiodes 121f-1 to 121f-4 to the output).

For example, by transferring electric charges of the photodiode 121f-1 and the photodiode 121f-3 to the FD unit 163 and adding signals obtained by reading individual electric charges, incident angle directivity in a left-right direction can be obtained. Similarly, by transferring electric charges of the photodiode 121f-1 and the photodiode 121f-2 to the FD unit 163 and adding signals obtained by reading individual electric charges, incident angle directivity in an up-down direction can be obtained.

Furthermore, a signal obtained on the basis of the electric charges selectively read independently from the four photodiodes 121f-1 to 121f-4 is a detection signal corresponding to one pixel constituting the detection image.

Note that the contribution of (an electric charge of) each photodiode 121f to the detection signal can also be achieved by resetting electric charges accumulated in the photodiode 121f before transfer to the FD unit 163 by using an electronic shutter function, and the like, for example, not only by depending on whether or not to transfer the electric charge (the detection value) of each photodiode 121f to the FD unit 163. For example, when the electric charge of the photodiode 121f is reset immediately before transfer to the FD unit 163, the photodiode 121f does not contribute to the detection signal at all. Whereas, by giving a time between resetting electric charges of the photodiode 121f and transferring the electric charge to the FD unit 163, the photodiode 121f is brought into a state of partially contributing to the detection signal.

As described above, in a case of the imaging element 121 in FIG. 6, different incident angle directivity can be given for each pixel by changing a combination of the four photodiodes 121f-1 to 121f-4 to be used for the detection signal. Furthermore, a detection signal outputted from each pixel 121a of the imaging element 121 in FIG. 6 is a value (an output pixel value) modulated in accordance with an incident angle of incident light from the subject, and has different characteristics (directivity) (has incident angle directivity) depending on the incident angle.

Note that, in the imaging element 121 of FIG. 6, since the incident light is incident on all the photodiodes 121f-1 to 121f-4 without being optically modulated, the detection signal is not a signal obtained by optical modulation. Furthermore, hereinafter, a photodiode 121f that does not contribute to the detection signal will also be referred to as a photodiode 121f that does not contribute to a pixel or output.

Furthermore, FIG. 6 illustrates an example in which a light-receiving surface of a pixel (the pixel 121a) is segmented into four equal parts, and the photodiodes 121f having light-receiving surfaces of the same size are arranged in individual regions, that is, the photodiode is segmented into four equal parts, but the number of segments and a segmented position of the photodiode can be freely set.

For example, it is not always necessary to segment the photodiode into equal parts, and the segmented position of the photodiode may be made different for each pixel. As a result, for example, even if the photodiodes 121f at the same position between a plurality of pixels contribute to the output, the incident angle directivity will differ between the pixels. Furthermore, for example, by making the number of segments different between the pixels, it becomes possible to set the incident angle directivity more freely. Moreover, for example, both the number of segments and the segmented position may be made different between the pixels.

Furthermore, both the imaging element 121 of FIG. 5 and the imaging element 121 of FIG. 6 have a configuration in which the incident angle directivity can be independently set in each pixel. Note that, in the imaging element 121 of FIG. 5, the incident angle directivity of each pixel is set by the light-shielding film 121b at a time of manufacturing. Whereas, in the imaging element 121 of FIG. 6, the number of segments and the segmented position of the photodiode of each pixel are set at the time of manufacturing, but the incident angle directivity of each pixel (a combination of photodiodes to contribute to the output) can be set at a time of using (for example, at a time of imaging). Note that, neither of the imaging element 121 of FIG. 5 and the imaging element 121 of FIG. 6 necessarily has a configuration in which all the pixels have incident angle directivity.

Note that, hereinafter, in the imaging element 121 of FIG. 5, a shape of the light-shielding film 121b of each pixel 121a is referred to as a light-shielding pattern. Furthermore, hereinafter, in the imaging element 121 of FIG. 6, a shape of a region of the photodiode 121f that does not contribute to the output in each pixel 121a is referred to as a light-shielding pattern.

<About Basic Characteristics and Like of Imaging Element 121>

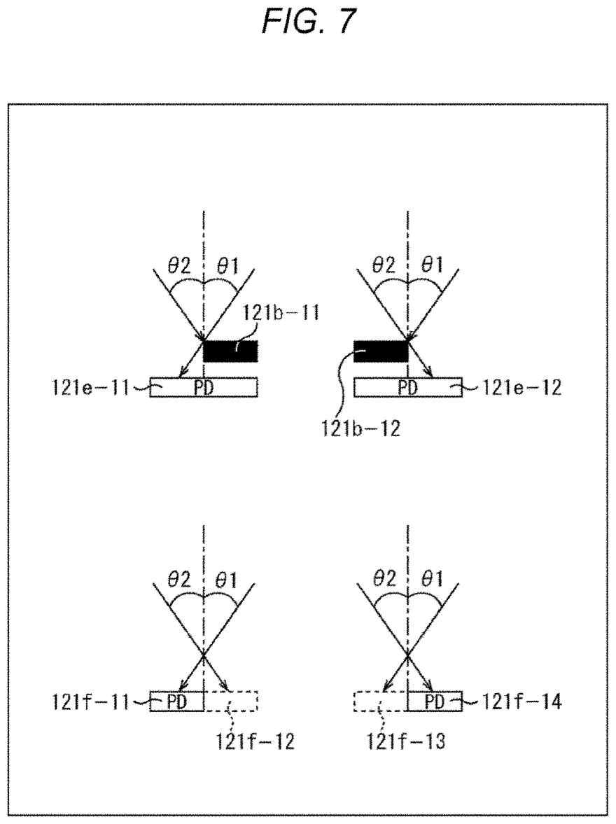

Next, basic characteristics and the like of the imaging element 121 will be described with reference to FIGS. 7 to 14.

<About Principle that Causes Incident Angle Directivity>

Incident angle directivity of each pixel of the imaging element 121 is generated by, for example, a principle illustrated in FIG. 7. Note that, an upper left part and an upper right part of FIG. 7 are views for explaining a principle of generation of incident angle directivity in the imaging element 121 of FIG. 5, and a lower left part and a lower right part of FIG. 7 are views for explaining a principle of generation of incident angle directivity in the imaging element 121 of FIG. 6.

Pixels in the upper left part and the upper right part of FIG. 7 both include one photodiode 121e. On the other hand, pixels in the lower left part and the lower right part of FIG. 7 both include two photodiodes 121f. Note that, although an example is shown in which one pixel includes two photodiodes 121f here, this is for convenience of explanation, and the number of photodiodes 121f included in one pixel may be other number.

In the pixel in the upper left part of FIG. 7, a light-shielding film 121b-11 is formed so as to shield light in a right half of a light-receiving surface of a photodiode 121e-11. Furthermore, in the pixel in the upper right part of FIG. 7, a light-shielding film 121b-12 is formed so as to shield light in a left half of a light-receiving surface of a photodiode 121e-12. Note that, a one dotted chain line in the figure is an auxiliary line that passes through a center in a horizontal direction of the light-receiving surface of the photodiode 121e and is perpendicular to the light-receiving surface.

For example, in the pixel in the upper left part of FIG. 7, incident light that is from an upper right direction and forms an incident angle θ1 with respect to the one dotted chain line in the figure is likely to be received by a left half range that is not light-shielded by the light-shielding film 121b-11 of the photodiode 121e-11. On the other hand, incident light that is from an upper left direction and forms an incident angle θ2 with respect to the one dotted chain line in the figure is unlikely to be received by the left half range that is not light-shielded by the light-shielding film 121b-11 of the photodiode 121e-11. Therefore, the pixel in the upper left part of FIG. 7 has incident angle directivity with high light-receiving sensitivity for incident light from the upper right in the figure and low light-receiving sensitivity for incident light from the upper left.

Whereas, for example, in the pixel in the upper right part of FIG. 7, incident light that is from an upper right direction and forms an incident angle θ1 is unlikely to be received by a left half range light-shielded by the light-shielding film 121b-12 of the photodiode 121e-12. On the other hand, incident light that is from an upper left direction and forms an incident angle θ2 is likely to be received by a right half range that is not light-shielded by the light-shielding film 121b-12 of the photodiode 121e-12. Therefore, the pixel in the upper right part of FIG. 7 has incident angle directivity with low light-receiving sensitivity for incident light from the upper right in the figure and high light-receiving sensitivity for incident light from the upper left.

Furthermore, the pixel in the lower left part of FIG. 7 is provided with photodiodes 121f-11 and 121f-12 on the left and right sides in the figure, and configured to have incident angle directivity without being provided with the light-shielding film 121b, by reading out a detection signal of either one.

That is, in the pixel in the lower left part of FIG. 7, incident angle directivity similar to that of the pixel in the upper left part of FIG. 7 can be obtained by reading out only a signal of the photodiode 121f-11 provided on the left side in the figure. That is, incident light that is from an upper right direction and forms an incident angle θ1 with respect to the one dotted chain line in the figure is incident on the photodiode 121f-11, and a signal corresponding to an amount of received light is read out from the photodiode 121f-11. Therefore, the incident light contributes to a detection signal outputted from this pixel. On the other hand, incident light that is from an upper left direction and forms an incident angle θ2 with respect to the one dotted chain line in the figure is incident on the photodiode 121f-12, but is not read from the photodiode 121f-12. Therefore, the incident light does not contribute to a detection signal outputted from this pixel.

Similarly, in a case where two photodiodes 121f-13 and 121f-14 are provided as in the pixel in the lower right part of FIG. 7, incident angle directivity similar to that of the pixel in the upper right part of FIG. 7 can be obtained by reading out only a signal of the photodiode 121f-14 provided on the right side in the figure. That is, incident light that is from an upper right direction and forms an incident angle θ1 is incident on the photodiode 121f-13, but a signal is not read from the photodiode 121f-13. Therefore, the incident light does not contribute to a detection signal outputted from this pixel. On the other hand, incident light that is from an upper left direction and forms an incident angle θ2 is incident on the photodiode 121f-14, and a signal corresponding to an amount of received light is read out from the photodiode 121f-14. Therefore, the incident light contributes to a detection signal outputted from this pixel.

Note that, an example has been shown in which a range that is light-shielded and a range that is not light-shielded are separated at a center position in the horizontal direction of the pixel (the light-receiving surface of the photodiode 121e) in the pixel in the upper part of FIG. 7, the range that is light-shielded and the range that is not light-shielded may be separated at another position. Furthermore, an example has been shown in which the two photodiodes 121f are separated at a center position in the horizontal direction of the pixel in the pixel in the lower part of FIG. 7, but the two photodiodes 121f may be separated at another position. In this way, different incident angle directivity can be generated by changing the light-shielding range or the position where the photodiode 121f is separated.

<About Incident Angle Directivity in Configuration Including On-Chip Lens>

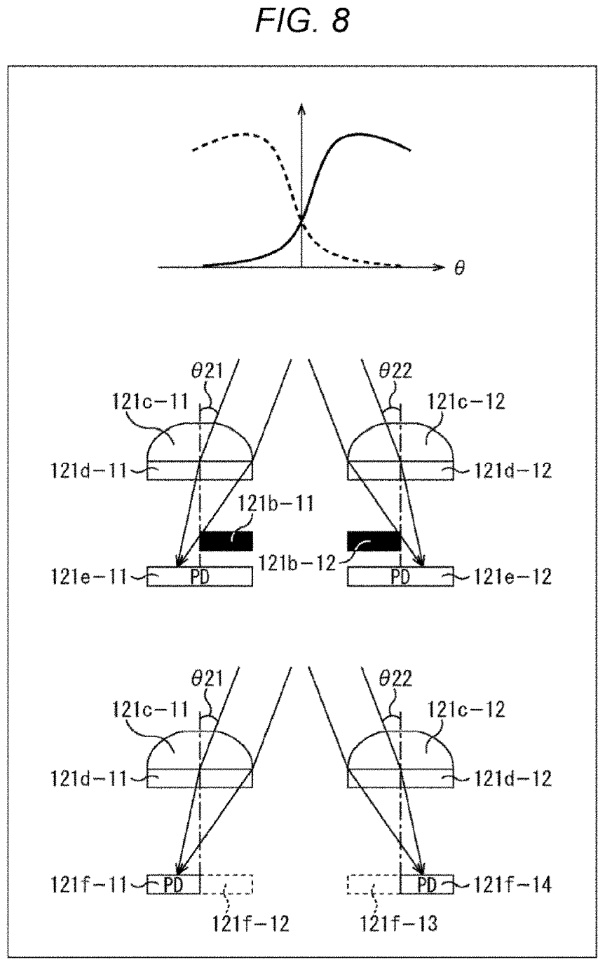

Next, with reference to FIG. 8, incident angle directivity in a configuration including an on-chip lens 121c will be described.

A graph in an upper stage of FIG. 8 shows incident angle directivity of pixels in middle and lower stages of FIG. 8. Note that a horizontal axis represents an incident angle θ, and a vertical axis represents a detection signal level. Note that, the incident angle θ is 0 degrees in a case where a direction of incident light coincides with a one dotted chain line on the left side of the middle stage in FIG. 8, and an incident angle θ21 side on the left side of the middle stage in FIG. 8 is set as a positive direction and an incident angle θ22 on the right side of the middle stage in FIG. 8 is set as a negative direction. Therefore, with respect to the on-chip lens 121c, incident light incident from the upper right has a larger incident angle than that of incident light incident from the upper left. That is, the incident angle θ increases (increases in the positive direction) as a traveling direction of the incident light is inclined to the left, and decreases (increases in the negative direction) as the traveling direction is inclined to the right.

Furthermore, a pixel in a left part of a middle stage of FIG. 8 is obtained by adding an on-chip lens 121c-11 that collects incident light and a color filter 121d-11 that transmits light of a predetermined wavelength, to the pixel in the left part of the upper stage of FIG. 7. That is, in this pixel, the on-chip lens 121c-11, the color filter 121d-11, the light-shielding film 121b-11, and the photodiode 121e-11 are laminated in order from an incident direction of light in an upper part in the figure.

Similarly, the pixel in a right part in the middle stage of FIG. 8, the pixel in a left part in a lower stage of FIG. 8, and the pixel in a right part in the lower stage of FIG. 8 are obtained by adding the on-chip lens 121c-11 and the color filter 121d-11, or an on-chip lens 121c-12 and the color filter 121d-12, to the pixel in the right part in the upper stage of FIG. 7, the pixel in the left part in the lower stage of FIG. 7, and the pixel in the right part in the lower stage of FIG. 7, respectively.

In the pixel of a left part in the middle stage in FIG. 8, a detection signal level (light-receiving sensitivity) of the photodiode 121e-11 changes in accordance with the incident angle θ of the incident light, as shown by a waveform of a solid line in the upper stage of FIG. 8. That is, as the incident angle θ is larger, which is an angle formed by incident light with respect to the one dotted chain line in the figure (as the incident angle θ is larger in the positive direction (is inclined more in the right direction in the figure)), the detection signal level of the photodiode 121e-11 becomes larger by light being collected in a range where the light-shielding film 121b-11 is not provided. Conversely, as the incident angle θ of the incident light is smaller (the incident angle θ is larger in the negative direction (is inclined more in the left direction in the figure)), the detection signal level of the photodiode 121e-11 becomes smaller by light being collected in a range where the light-shielding film 121b-11 is provided.

Furthermore, in the pixel of the right part in the middle stage in FIG. 8, a detection signal level (light-receiving sensitivity) of the photodiode 121e-12 changes in accordance with the incident angle θ of the incident light, as shown by a waveform of a dotted line in the upper stage of FIG. 8. That is, as the incident angle θ of incident light is larger (as the incident angle θ is larger in the positive direction), the detection signal level of the photodiode 121e-12 becomes smaller by light being collected in a range where the light-shielding film 121b-12 is provided. Conversely, as the incident angle θ of the incident light is smaller (the incident angle θ is larger in the negative direction), the detection signal level of the photodiode 121e-12 becomes larger by light being incident in a range where the light-shielding film 121b-12 is not provided.

Waveforms of the solid line and the dotted line illustrated in the upper stage of FIG. 8 can be changed in accordance with a range of the light-shielding film 121b. Therefore, depending on the range of the light-shielding film 121b, it is possible to give mutually different incident angle directivity on a pixel basis.

As described above, the incident angle directivity is characteristics of light-receiving sensitivity of each pixel according to the incident angle θ, but this can be said as characteristics of a light-shielding value according to the incident angle θ in the pixel in the middle stage of FIG. 8. That is, the light-shielding film 121b shields incident light in a specific direction at a high level, but cannot sufficiently shield incident light from other directions. This change in the light-shielding level causes different detection signal levels according to the incident angle θ as illustrated in the upper stage of FIG. 8. Therefore, when a direction in which light can be shielded at the highest level for each pixel is defined as a light-shielding direction of each pixel, having mutually different incident angle directivity on a pixel basis means, in other words, having a mutually different light-shielding direction on a pixel basis.

Furthermore, in the pixel in the left part in the lower stage of FIG. 8, by using a signal of only the photodiode 121f-11 in a left part in the figure, similarly to the case of the pixel in the left part in the lower stage of FIG. 7, it is possible to obtain incident angle directivity similar to that of the pixel in the left part in the middle stage of FIG. 8. That is, when the incident angle θ of the incident light becomes larger (when the incident angle θ becomes larger in the positive direction), the detection signal level becomes larger by light being collected in a range of the photodiode 121f-11 from which a signal is read. Conversely, as the incident angle θ of the incident light is smaller (the incident angle θ is larger in the negative direction), the detection signal level becomes smaller by light being collected in a range of the photodiode 121f-12 from which the signal is not read.

Furthermore, similarly, in the pixel in the right part in the lower stage of FIG. 8, by using a signal of only the photodiode 121f-14 in a right part in the figure, similarly to the pixel on the right side in the lower stage of FIG. 7, it is possible to obtain incident angle directivity similar to that of the pixel in the right part in the middle stage of FIG. 8. That is, when the incident angle θ of the incident light becomes larger (when the incident angle θ becomes larger in the positive direction), a detection signal level on a pixel basis becomes smaller by light being collected in a range of the photodiode 121f-13 that does not contribute to the output (the detection signal). Conversely, as the incident angle θ of the incident light is smaller (the incident angle θ is larger in the negative direction), the detection signal level on a pixel basis becomes larger by light being collected in a range of the photodiode 121f-14 that contributes to the output (the detection signal).

Here, a barycenter of the incident angle directivity of the pixel 121a is defined as follows.

The barycenter of the incident angle directivity is a barycenter of distribution of intensity of incident light incident on the light-receiving surface of the pixel 121a. The light-receiving surface of the pixel 121a is to be the light-receiving surface of the photodiode 121e in the pixel 121a in the middle stage of FIG. 8, and to be a light-receiving surface of the photodiode 121f in the pixel 121a in the lower stage of FIG. 8.

For example, a detection signal level on the vertical axis of the graph in the upper stage of FIG. 8 is defined as a(θ), and a light beam of an incident angle Gg calculated by the following Equation (4) is defined as a barycenter light beam.

θg=Σ(a(θ)×θ)/Σa(θ) (4)

Then, a point where the barycenter light beam intersects the light-receiving surface of the pixel 121a is to be the barycenter of the incident angle directivity of the pixel 121a.

Furthermore, as in the pixel in the lower stage of FIG. 8, in the pixel in which a plurality of photodiodes is provided in the pixel and the photodiode that contributes to the output can be changed, in order to provide each photodiode with directivity with respect to an incident angle of incident light, and to cause incident angle directivity on a pixel basis, the on-chip lens 121c is to be an indispensable configuration for each pixel.

Note that, in the following description, an example of a case will be mainly described in which the pixel 121a that achieves incident angle directivity by using the light-shielding film 121b is used as in the pixel 121a of FIG. 5. However, except a case where the light-shielding film 121b is indispensable, it is also basically possible to use the pixel 121a that achieves incident angle directivity by segmenting the photodiode.

<About Relationship Between Light-Shielding Range and Angle of View>

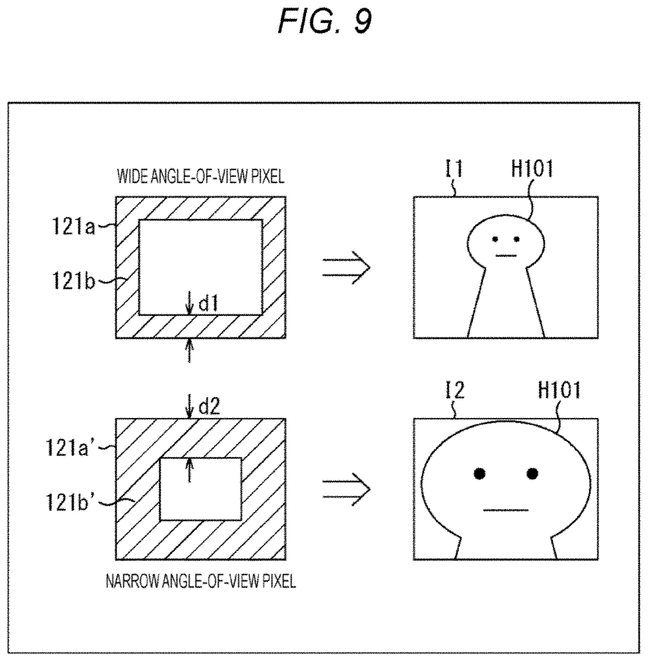

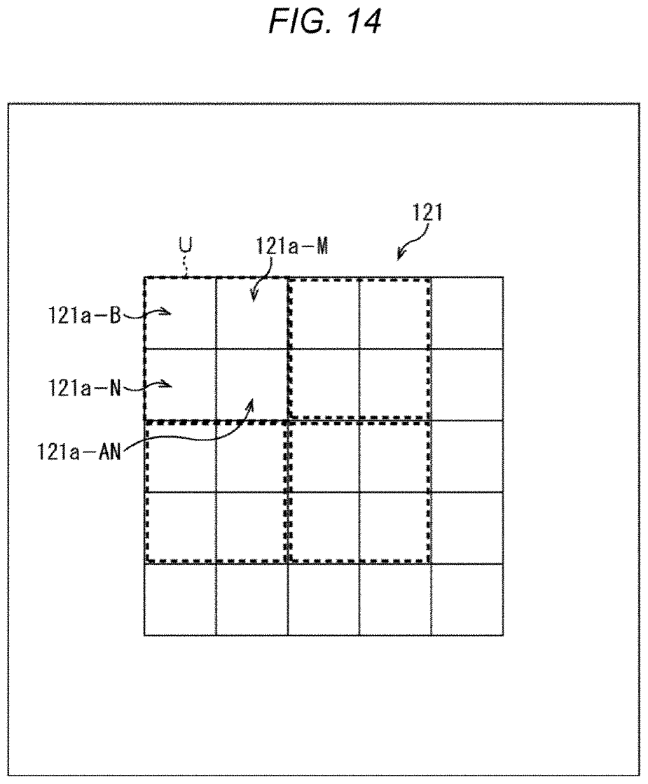

Next, a relationship between a light-shielding range and an angle of view of the pixel 121a will be described with reference to FIGS. 9 and 14.

For example, consider a pixel 121a that is light-shaded by the light-shielding film 121b by a width d1 from each end of four sides as illustrated in an upper stage of FIG. 9, and a pixel 121a′ that is light-shielded by the light-shielding film 121b by a width d2 (>d1) from each end of four sides as illustrated in a lower stage of FIG. 9.

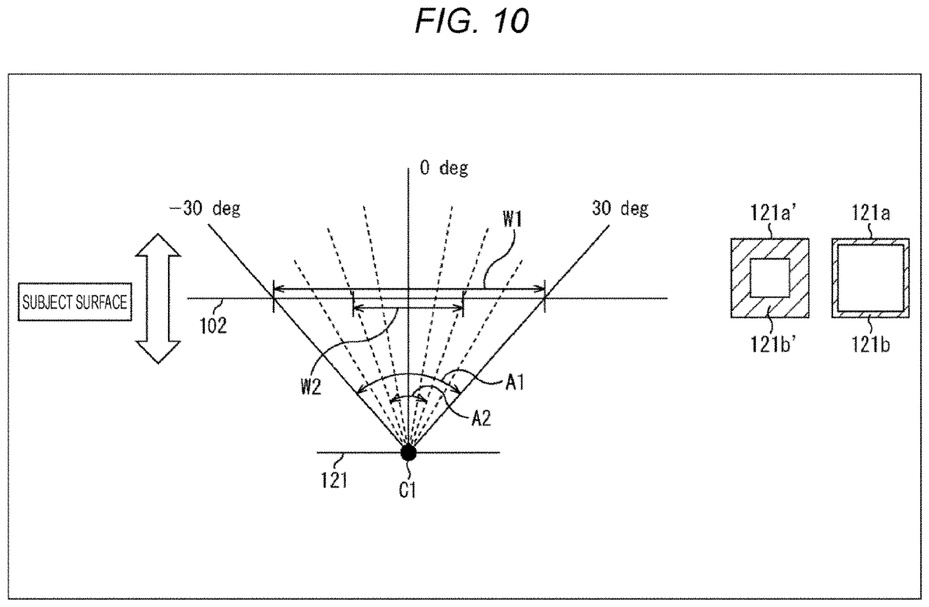

FIG. 10 illustrates an example of an incident angle of incident light on a center position Cl of the imaging element 121 from the subject surface 102. Note that, FIG. 10 illustrates an example of an incident angle of incident light in a horizontal direction, but this applies to a vertical direction in a substantially similar manner. Furthermore, in a right part of FIG. 10, the pixels 121a and 121a′ in FIG. 9 are illustrated.

For example, in a case where the pixel 121a of FIG. 9 is arranged at the center position Cl of the imaging element 121, a range of an incident angle of incident light from the subject surface 102 to the pixel 121a is to be an angle A1 as illustrated in a left part of FIG. 10. Therefore, the pixel 121a can receive incident light having a width W1 in the horizontal direction of the subject surface 102.

On the other hand, in a case where the pixel 121a′ in FIG. 9 is arranged at the center position Cl of the imaging element 121, since the pixel 121a′ has a wider range to be light-shielded than that of the pixel 121a, a range of an incident angle of incident light from the subject surface 102 to the pixel 121a′ is to be an angle A2 (<A1) as illustrated in the left part of FIG. 10. Therefore, the pixel 121a′ can receive incident light having a width W2 (<W1) in the horizontal direction of the subject surface 102.

That is, while the pixel 121a having a narrow light-shielding range is a wide angle-of-view pixel suitable for capturing an image of a wide range on the subject surface 102, the pixel 121a′ having a wide light-shielding range is a narrow angle-of-view pixel suitable for capturing an image of a narrow range on the subject surface 102. Note that the wide angle-of-view pixel and the narrow angle-of-view pixel referred to here are expressions for comparing both the pixels 121a and 121a′ in FIG. 9, and are not limited to this when comparing pixels with other angles of view.

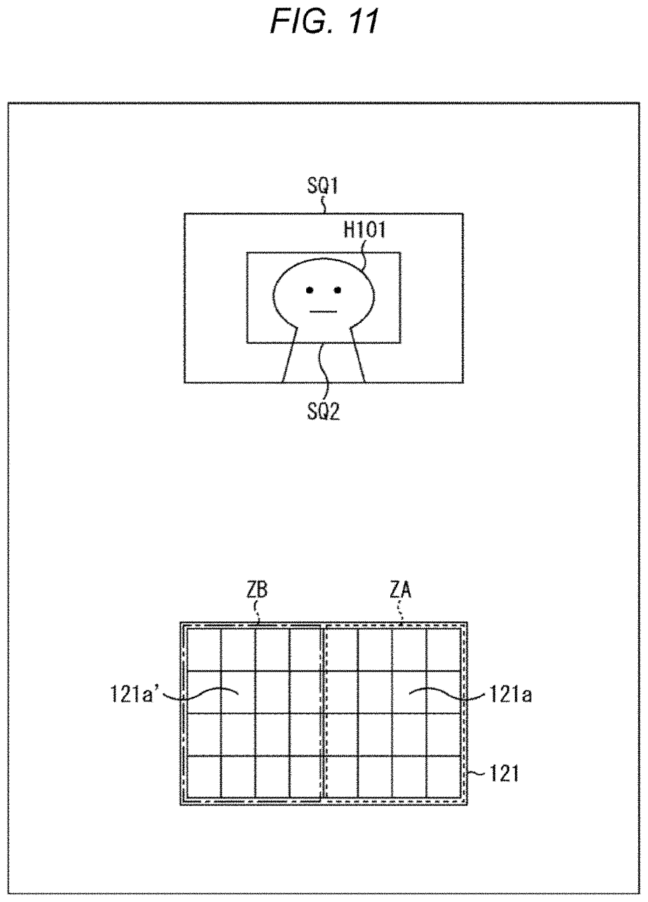

Therefore, for example, the pixel 121a is used to restore an image I1 of FIG. 9. The image I1 is an image having an angle of view SQ1 including a person H101 as a whole as the subject in an upper stage of FIG. 11 and corresponding to the subject width W1. On the other hand, for example, the pixel 121a′ is used to restore an image 12 of FIG. 9. The image 12 is an image of an angle of view SQ2 having a zoomed periphery of the face of the person H101 in the upper stage of FIG. 11 and corresponding to a subject width W2.

Furthermore, for example, as illustrated in a lower stage of FIG. 11, it is conceivable to collect and arrange, in the imaging element 121, a predetermined number of the pixels 121a of FIG. 9 in a range ZA surrounded by a dotted line, and a predetermined number of the pixels 121a′ in a range ZB surrounded by a one dotted chain line. Then, for example, when restoring an image having the angle of view SQ1 corresponding to the subject width W1, the image having the angle of view SQ1 can be restored appropriately by using a detection signal of each pixel 121a in the range ZA. Whereas, when restoring an image having the angle of view SQ2 corresponding to the subject width W2, the image having the angle of view SQ2 can be appropriately restored by using a detection signal of each pixel 121a′ in the range ZB.

Note that, in a case where the images of the angle of view SQ2 and the angle of view SQ1 are restored with the same number of pixels, it is possible to obtain a higher quality (higher resolution) restored image in restoring the image having the angle of view SQ2 than in restoring the image having the angle of view SQ1, since the angle of view SQ2 is narrower than the angle of view SQ1.

That is, in a case of considering obtaining a restored image by using the same number of pixels, it is possible to obtain a restored image with higher image quality by restoring an image having a narrower angle of view.

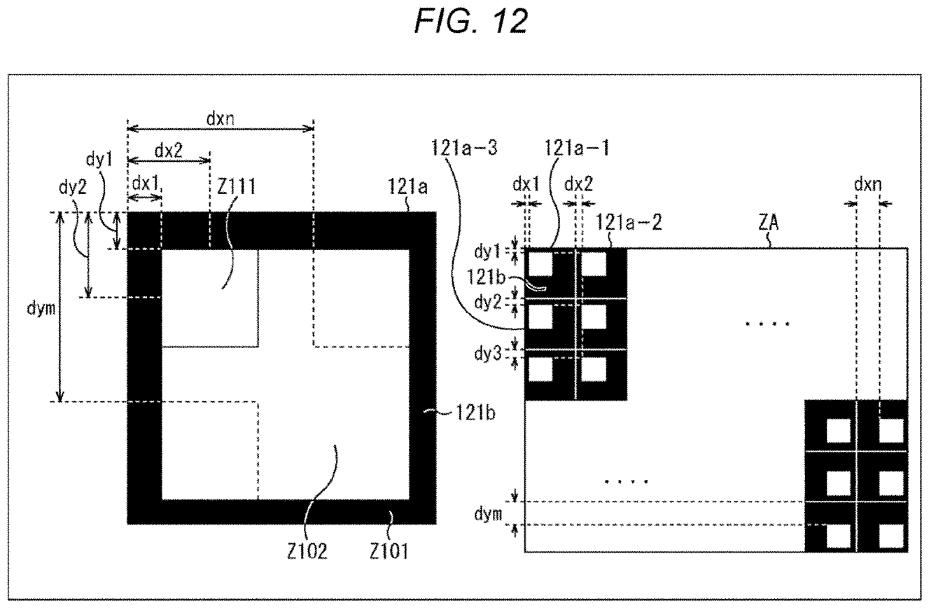

For example, a right part of FIG. 12 illustrates a configuration example of the imaging element 121 of FIG. 11 in the range ZA. A left part of FIG. 12 illustrates a configuration example of the pixel 121a in the range ZA.

In FIG. 12, a range shown in black is the light-shielding film 121b, and a light-shielding range of each pixel 121a is determined in accordance with, for example, a rule shown in the left part of FIG. 12.

A main light-shielding part Z101 on the left side of FIG. 12 (a black part in the left part of FIG. 12) is a range that is light-shielded in each pixel 121a in common. Specifically, the main light-shielding part Z101 has a range of a width dx1 individually from a left edge and a right edge of the pixel 121a toward inside the pixel 121a, and a range of a height dy1 individually from an upper edge and a lower edge of the pixel 121a toward inside the pixel 121a. Then, in each pixel 121a, a rectangular opening Z111 that is not light-shielded by the light-shielding film 121b is provided in a range Z102 inside the main light-shielding part Z101. Therefore, in each pixel 121a, a range other than the opening Z111 is light-shielded by the light-shielding film 121b.

Here, the openings Z111 of the individual pixels 121a are regularly arranged. Specifically, positions of the openings Z111 in the horizontal direction in the individual pixels 121a are the same in the same column in a vertical direction of the pixels 121a. Furthermore, positions of the openings Z111 in the vertical direction in the individual pixels 121a are the same in the pixel 121a in the same row in the horizontal direction.

Whereas, positions of the opening Z111 in the horizontal direction in the individual pixels 121a are shifted at a predetermined interval in accordance with the position of the pixel 121a in the horizontal direction. That is, as the position of the pixel 121a advances in a right direction, a left edge of the opening Z111 moves to a position shifted in the right direction by the widths dx1, dx2, . . . , dxn individually from the left edge of the pixel 121a. A distance between the width dx1 and the width dx2, a distance between the width dx2 and the width dx3, . . . , and a distance between a width dxn−1 and the width dxn are to be values individually obtained by dividing a length obtained by subtracting a width of the opening Z111 from a width of the range Z102 in the horizontal direction, by the number of pixels n−1 in the horizontal direction.

Furthermore, positions of the openings Z111 in the vertical direction in the individual pixels 121a are shifted at a predetermined interval in accordance with the position of the pixel 121a in the vertical direction. That is, as the position of the pixel 121a advances in a downward direction, an upper edge of the opening Z111 moves to a position shifted in the downward direction by heights dy1, dy2, . . . , dyn individually from the upper edge of the pixel 121a. A distance between the height dy1 and the height dy2, a distance between the height dy2 and the height dy3, . . . , and a distance between a height dyn−1 and the height dyn are to be values individually obtained by dividing a length obtained by subtracting a height of the opening Z111 from a height of the range Z102 in the vertical direction, by the number of pixels m−1 in the vertical direction.

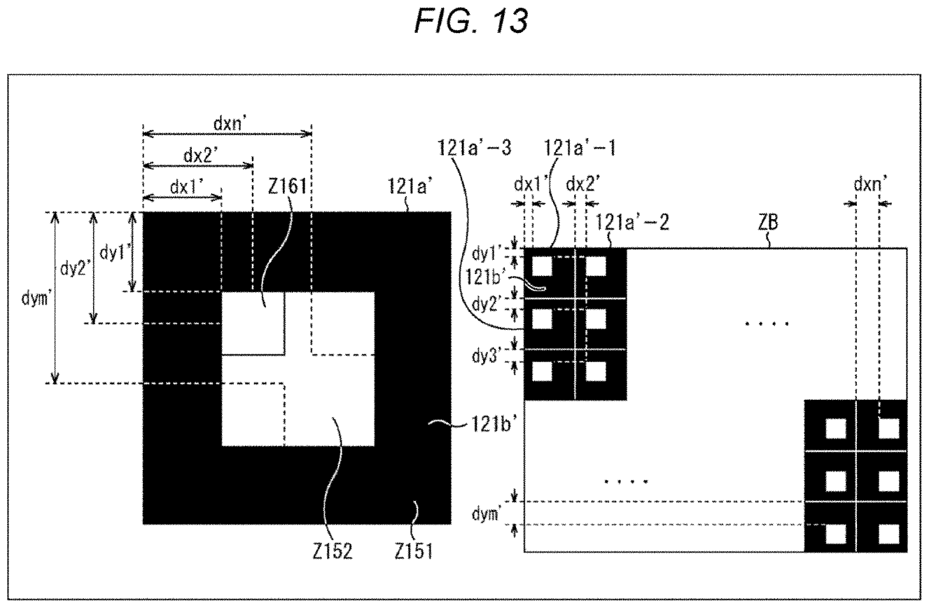

A right part of FIG. 13 illustrates a configuration example of the imaging element 121 of FIG. 11 in the range ZB. A left part of FIG. 13 illustrates a configuration example of the pixel 121a′ in the range ZB.

In FIG. 13, a range shown in black is a light-shielding film 121b′, and a light-shielding range of each pixel 121a′ is determined in accordance with, for example, a rule shown in the left part of FIG. 13.

A main light-shielding part Z151 on the left side of FIG. 13 (a black part in the left part of FIG. 13) is a range that is light-shielded in each pixel 121a′ in common. Specifically, the main light-shielding part Z151 has a range of a width dx1′ individually from a left edge and a right edge of the pixel 121a′ toward inside the pixel 121a′, and a range of a height dy1′ individually from an upper edge and a lower edge of the pixel 121a′ toward inside the pixel 121a′. Then, in each pixel 121a′, a rectangular opening Z161 that is not light-shielded by the light-shielding film 121b′ is provided in a range Z152 inside the main light-shielding part Z151. Therefore, in each pixel 121a′, a range other than the opening Z161 is light-shielded by the light-shielding film 121b′.

Here, the openings Z161 of the individual pixels 121a′ are regularly arranged in a similar manner to the openings Z111 of the individual pixels 121a of FIG. 12. Specifically, positions of the openings Z161 in a horizontal direction in the individual pixels 121a′ are the same in the same column in a vertical direction of the pixels 121a′. Furthermore, positions of the openings Z161 in the vertical direction in the individual pixels 121a′ are the same in the pixel 121a′ in the same row in the horizontal direction.

Whereas, positions of the opening Z161 in the horizontal direction in the individual pixels 121a′ are shifted at a predetermined interval in accordance with the position of the pixel 121a′ in the horizontal direction. That is, as the position of the pixel 121a′ advances in a right direction, a left edge of the opening Z161 moves to a position shifted in the right direction by the widths dx1′, dx2′, . . . , dxn′ individually from the left edge of the pixel 121a′. A distance between the width dx1′ and the width dx2′, a distance between the width dx2′ and the width dx3′, . . . , and a distance between a width dxn−1′ and the width dxn′ are to be values individually obtained by dividing a length obtained by subtracting a width of the opening Z161 from a width of the range Z152 in the horizontal direction, by the number of pixels n−1 in the horizontal direction.

Furthermore, positions of the openings Z161 in the vertical direction in the individual pixels 121a′ are shifted at a predetermined interval in accordance with the position of the pixel 121a′ in the vertical direction. That is, as the position of the pixel 121a′ advances in a downward direction, an upper edge of the opening Z161 moves to a position shifted in the downward direction by heights dy1′, dy2′, . . . , dyn′ individually from the upper edge of the pixel 121a′. A distance between the height dy1′ and the height dy2′, a distance between the height dy2′ and the height dy3′, . . . , and a distance between a height dyn−1′ and the height dyn′ are to be values individually obtained by dividing a length obtained by subtracting a height of the opening Z161 from a height of the range Z152 in the vertical direction, by the number of pixels m−1 in the vertical direction.

Here, the length obtained by subtracting the width of the opening Z111 from the width of the range Z102 of the pixel 121a in the horizontal direction in FIG. 12 is larger than the width obtained by subtracting the width of the opening Z161 from the width of the range Z152 of the pixel 121a′ in the horizontal direction in FIG. 13. Therefore, an interval of change of the widths dx1, dx2 . . . dxn in FIG. 12 is larger than an interval of change of the widths dx1′, dx2′ . . . dxn′ in FIG. 13.

Furthermore, the length obtained by subtracting the height of the opening Z111 from the height of the range Z102 of the pixel 121a in the vertical direction in FIG. 12 is larger than the length obtained by subtracting the height of the opening Z161 from the height of the range Z152 of the pixel 121a′ in the vertical direction in FIG. 13. Therefore, an interval of change of the heights dy1, dy2 . . . dyn in FIG. 12 is larger than an interval of change of the heights dy1′, dy2′ . . . dyn′ in FIG. 13.

In this way, the interval of change in the position in the horizontal and vertical directions of the opening Z111 of the light-shielding film 121b of each pixel 121a in FIG. 12 is different from the interval of change in the position in the horizontal and vertical directions of the opening Z161 of the light-shielding film 121b′ of each pixel 121a′ in FIG. 13. Then, the difference in the interval is to be a difference in a subject resolution (an angle resolution) in the restored image. That is, the interval of change in the position in the horizontal and vertical directions of the opening Z161 of the light-shielding film 121b′ of each pixel 121a′ in FIG. 13 is to be narrower than the interval of change in the position in the horizontal and vertical directions of the opening Z111 of the light-shielding film 121b of each pixel 121a in FIG. 12. Therefore, a restored image restored using a detection signal of each pixel 121a′ in FIG. 13 has higher subject resolution and higher image quality (a higher resolution) than that of a restored image restored using a detection signal of each pixel 121a in FIG. 12.

In this way, by changing the combination of the light-shielding range of the main light-shielding part and the opening range of the opening, the imaging element 121 including pixels having various angles of view (having various incident angle directivities) can be achieved.

Note that, in the above, an example has been shown in which the pixels 121a and the pixels 121a′ are arranged separately in the range ZA and the range ZB, but this is for the sake of simplicity, and the pixels 121a corresponding to different angles of view are desirably mixed and arranged in the same region.

For example, as illustrated in FIG. 14, four pixels including 2 pixels×2 pixels shown by a dotted line are regarded as one unit U, and each unit U is configured by four pixels of: a wide angle-of-view pixel 121a-W; a medium angle-of-view pixel 121a-M; a narrow angle-of-view pixel 121a-N; and an extremely narrow angle-of-view pixel 121a-AN.

In this case, for example, in a case where the number of pixels of all the pixels 121a is X, it is possible to restore a restored image by using detection images of X/4 pixels for every four types of angles of view. At this time, four types of coefficient set groups that are different for each angle of view are used, and restored images with individually different angles of view are restored by four different simultaneous equations.

Therefore, by restoring a restored image by using a detection image obtained from among pixels suitable for capturing an image having an angle of view of the restored image to be restored, it is possible to obtain an appropriate restored image according to the four types of angles of view.

Furthermore, an image of an angle of view in the middle of the four types of angles of view and/or of angles of view before and after may be interpolated and generated from the images of the four types of angles of view, and a pseudo optical zoom may be realized by seamlessly generating images of various angles of view.

Note that, for example, in a case where an image having a wide angle of view is obtained as a restored image, all the wide angle-of-view pixels may be used, or some of the wide angle-of-view pixels may be used. Furthermore, for example, in a case where an image having a narrow angle of view is obtained as a restored image, all the narrow angle-of-view pixels may be used, or some of the narrow angle-of-view pixels may be used.

Note that, hereinafter, in the first embodiment of the present technology, an example will be described in which the imaging element 121 includes the pixel 121a and the pixel 121a′, and detection images can be captured with two types of angles of view of a wide angle of view (for example, the angle of view SQ1) and a narrow angle of view (for example, the angle of view SQ2), as illustrated in FIG. 11. Furthermore, hereinafter, the pixel 121a is referred to as a wide angle-of-view pixel, and the pixel 121a′ is referred to as a narrow angle-of-view pixel.

<Configuration Example of Control Unit 28>

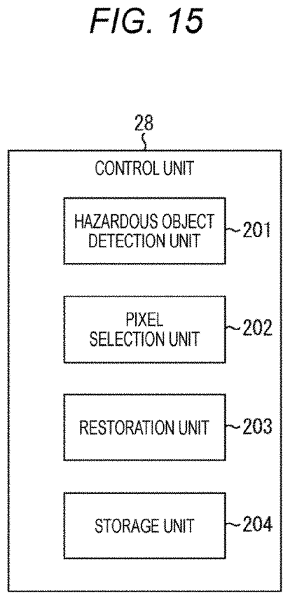

FIG. 15 illustrates a configuration example of a function of the control unit 28 of FIG. 1. The control unit 28 includes a hazardous object detection unit 201, a pixel selection unit 202, a restoration unit 203, and a storage unit 204.

The hazardous object detection unit 201 performs a hazardous object detection process on the basis of a recognition result of an object in front of the vehicle by the recognition unit 23.

The pixel selection unit 202 selects a pixel to be used for monitoring the front of the vehicle, on the basis of information obtained from a detection signal outputted from each pixel 121a among the pixels 121a of the imaging element 121. Specifically, the pixel selection unit 202 selects which of the wide angle-of-view pixel or the narrow angle-of-view pixel is to be used for monitoring the front of the vehicle, on the basis of a detection result of the hazardous object by the hazardous object detection unit 201, and the like. In other words, on the basis of a detection result of the hazardous object by the hazardous object detection unit 201, and the like, the pixel selection unit 202 select which image to be used for monitoring the front of the vehicle, from among a wide angle-of-view restored image corresponding to the wide angle-of-view pixel and a narrow angle-of-view restored image corresponding to the narrow angle-of-view pixel.

The restoration unit 203 acquires, from the storage unit 204, a coefficient set group corresponding to the coefficients α1 to α3, β1 to β3, and γ1 to γ3 described above, and corresponding to, for example, a pixel selected by the pixel selection unit 202 and a subject distance corresponding to a distance from the imaging element 121 in FIG. 3 to the subject surface 102 (a subject surface corresponding to the restored image). Furthermore, the restoration unit 203 creates simultaneous equations represented by the above Equations (1) to (3), by using a detection signal level of each pixel of a detection image outputted from the imaging element 121 and using the acquired coefficient set group. Then, by solving the created simultaneous equations, the restoration unit 203 obtains a pixel value of each pixel constituting an image illustrated in the lower right of FIG. 3 in which an image of the subject is formed. As a result, a restored image in which the user can visually recognize the subject (the subject is visible) is restored from the detection image.

Note that, in a case where the imaging element 121 has sensitivity only to light other than a visible wavelength band, such as ultraviolet rays, the restored image is also not to be an image in which the subject can be identified as in a normal image, but in this case as well, it is referred to as the restored image.

Furthermore, hereinafter, a restored image that is an image in a state where an image of the subject is formed and before color separation such as demosaic processing or synchronization processing is called a RAW image, and a detection image captured by the imaging element 121 is distinguished as not being the RAW image although the image follows an array of color filters.

Note that the number of pixels of the imaging element 121 and the number of pixels of the pixels constituting the restored image do not necessarily need to be the same.

Furthermore, the restoration unit 203 performs demosaic processing, gamma correction, white balance adjustment, conversion processing to a predetermined compression format, and the like on the restored image, if necessary. Then, the restoration unit 203 outputs the restored image to the bus β2.

The storage unit 204 includes one or more storage devices such as a ROM, a RAM, and a flash memory, and stores, for example, a program and data to be used for processing by the control unit 28. For example, the storage unit 204 stores a coefficient set group corresponding to the coefficients α1 to α3, β1 to β3, and γ1 to γ3 described above in association with various subject distances and angles of view. More specifically, for example, for each subject surface 102 at each subject distance, the storage unit 204 stores a coefficient set group including a coefficient that is for each pixel 121a of the imaging element 121 for each point light source and is set for each angle of view on the subject surface 102.

<Monitoring Process>

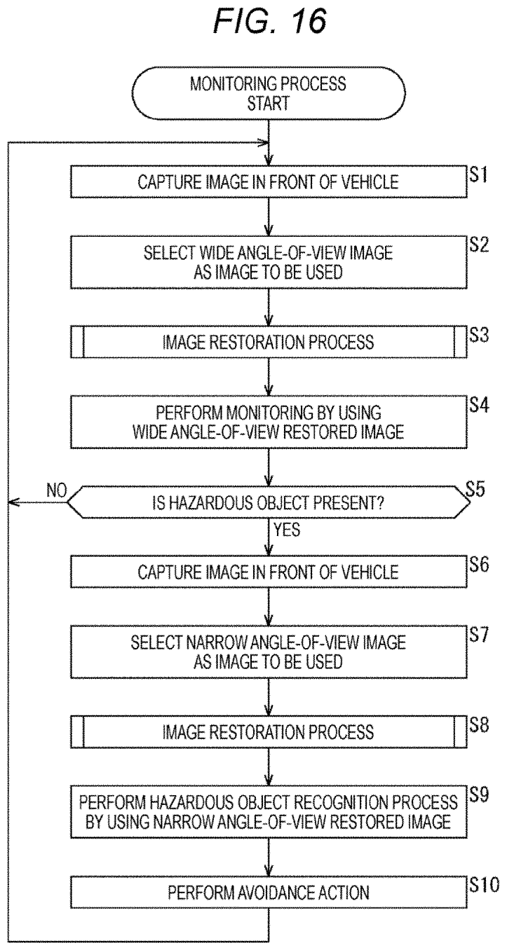

Next, with reference to a flowchart of FIG. 16, a monitoring process executed by the information processing system 11 will be described.

This process starts, for example, when power of the vehicle including the information processing system 11 is turned on, and ends when the power is turned off.

In step S1, the imaging element 121 captures an image of the front of the vehicle. As a result, a detection signal indicating a detection signal level according to an amount of incident light from the subject is outputted from each pixel of the imaging element 121 having different incident angle directivity, and a wide angle-of-view detection image including a detection signal of each wide angle-of-view pixel and a narrow angle-of-view detection image including a detection signal of each narrow angle-of-view pixel are obtained. The imaging element 121 supplies the wide angle-of-view detection image and the narrow angle-of-view detection image to the control unit 28 via the communication unit 124, the camera ECU 42, and the MCU 43.

In step S2, the pixel selection unit 202 selects a wide angle-of-view image as an image to be used. That is, the pixel selection unit 202 selects a wide angle-of-view restored image restored from the wide angle-of-view detection image, as the image to be used for monitoring the front of the vehicle. As a result, a wide angle-of-view pixel is selected as a pixel of the imaging element 121 to be used for monitoring, and the wide angle-of-view detection image including a detection signal outputted from each wide angle-of-view pixel is selected as a restoration target of the process in step S3.

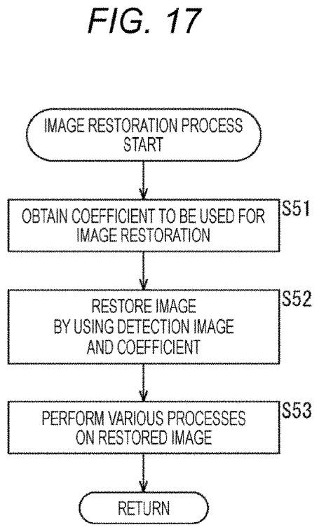

In step S3, the restoration unit 203 executes an image restoration process. While details of the image restoration process will be described later with reference to FIG. 17, this process restores the wide angle-of-view restored image from the wide angle-of-view detection image.

In step S4, the information processing system 11 performs monitoring by using the wide angle-of-view restored image.

Specifically, the recognition unit 23 performs an object recognition process on the wide angle-of-view restored image, and recognizes a position, a size, a type, a movement, and the like of an object in front of the vehicle. The recognition unit 23 supplies the wide angle-of-view restored image and data indicating a recognition result of the object, to the hazardous object detection unit 201.

The hazardous object detection unit 201 detects a hazardous object having a risk of colliding or contacting with the vehicle, on the basis of a current position, a speed, and a moving direction of the vehicle, and the position, the size, the type, the movement, and the like of the object recognized by the recognition unit 23.

For example, the hazardous object detection unit 201 detects, as a hazardous object, an object whose distance between with the vehicle in front of the vehicle is within a predetermined range, and whose relative speed in a direction of approaching the vehicle is equal to or higher than a predetermined threshold value (an object approaching the vehicle at a speed equal to or higher than a predetermined threshold value).

Alternatively, for example, the hazardous object detection unit 201 detects, as a hazardous object, an object that is on a travel planning route of the vehicle, and whose relative speed in a direction of approaching the vehicle is equal to or higher than a predetermined threshold value (an object approaching the vehicle at a speed equal to or higher than a predetermined threshold value).

The hazardous object detection unit 201 supplies the wide angle-of-view restored image and data indicating a detection result of a hazardous object, to the alert control unit 24 and the operation control unit 27.

The alert control unit 24 performs a process of superimposing a warning display that calls attention to a hazardous object on the wide angle-of-view restored image, on the basis of a detection result of a hazardous object in front of the vehicle. For example, in order to emphasize a hazardous object in the wide angle-of-view restored image, a display effect such as surrounding with a frame is applied. The alert control unit 24 supplies the wide angle-of-view restored image on which the warning display is superimposed, to the display control unit 26.

Note that, in a case where a hazardous object has not been detected, the alert control unit 24 supplies the wide angle-of-view restored image to the display control unit 26 as it is without superimposing the warning display.

The display unit 25 displays the wide angle-of-view restored image under the control of the display control unit 26. At this time, in a case where a hazardous object has been detected, the warning display is performed on the wide angle-of-view restored image. As a result, the driver can quickly and reliably recognize the presence of the hazardous object in front of the vehicle.

In step S5, the hazardous object detection unit 201 determines whether or not the hazardous object is present on the basis of a result of the process in step S4. In a case where it is determined that a hazardous object is not present, the process returns to step S1.

Thereafter, the processes of steps S1 to S5 are repeatedly executed until it is determined in step S5 that a hazardous object is present. That is, in a case where no hazardous object is detected, monitoring using the wide angle-of-view restored image is repeatedly executed.

Whereas, in a case where it is determined in step S5 that a hazardous object is present, the process proceeds to step S6.

In step S6, an image in front of the vehicle is captured similarly to the process of step S1. As a result, a wide angle-of-view detection image and a narrow angle-of-view detection image are obtained.

In step S7, the pixel selection unit 202 selects a narrow angle-of-view image as an image to be used. That is, the pixel selection unit 202 selects a narrow angle-of-view restored image restored from the narrow angle-of-view detection image, as the image to be used for monitoring the front of the vehicle. As a result, a narrow angle-of-view pixel is selected as a pixel of the imaging element 121 to be used for monitoring, and the narrow angle-of-view detection image including a detection signal outputted from each narrow angle-of-view pixel is selected as a restoration target of the process of step S8.

In step S8, the restoration unit 203 executes the image restoration process. While details of the image restoration process will be described later with reference to FIG. 17, this process restores the narrow angle-of-view restored image from the narrow angle-of-view detection image.

In step S9, the recognition unit 23 performs a hazardous object recognition process by using the narrow angle-of-view restored image. Specifically, the recognition unit 23 performs the object recognition process on the narrow angle-of-view restored image, and recognizes a position, a size, a type, a movement, and the like of the hazardous object detected in the process of step S4 in more detail. That is, the narrow angle-of-view restored image has a center matching that of the wide angle-of-view restored image, has an angle of view narrower than that of the wide angle-of-view restored image, and has high image quality (high resolution). Therefore, the position, the size, the type, the movement, and the like of the hazardous object are recognized in more detail as compared with the process of step S3. The recognition unit 23 supplies data indicating a recognition result of the hazardous object to the operation control unit 27.

In step S10, the operation control unit 27 performs an avoidance action. Specifically, the operation control unit 27 controls a traveling direction, a speed, a brake, and the like of the vehicle so as not to collide or contact with the hazardous object, on the basis of the recognition result of the hazardous object based on the narrow angle-of-view restored image.

Thereafter, the process returns to step S1, and the processes of steps S1 to S10 are repeatedly executed.

<Image Restoration Process>

Next, details of the image restoration process corresponding to the processes of steps S3 and S8 of FIG. 16 will be described with reference to the flowchart of FIG. 17.

In step S51, the restoration unit 203 obtains a coefficient to be used for image restoration. Specifically, the restoration unit 203 sets a distance to the subject surface 102 that is to be the restoration target, that is, a subject distance. Note that, any method can be adopted as a method for setting the subject distance. For example, the restoration unit 203 sets a subject distance set by the user or a subject distance detected by various sensors, as the distance to the subject surface 102 to be the restoration target.

Next, the restoration unit 203 reads out a coefficient set group associated with the set subject distance, from the storage unit 123. At this time, the restoration unit 203 reads out a coefficient set group for a wide angle-of-view detection image from the storage unit 123 in a case of restoring a wide angle-of-view restored image, and reads out a coefficient set group for a narrow angle-of-view detection image from the storage unit 123 in a case of restoring a narrow angle-of-view restored image.

In step S52, the restoration unit 203 restores an image by using a detection image and a coefficient. Specifically, the restoration unit 203 creates the simultaneous equations described with reference to Equations (1) to (3) described above, by using a detection signal level of each pixel of the detection image and using the coefficient set group acquired in the process of step S51. Next, the restoration unit 203 calculates a light intensity of each point light source on the subject surface 102 corresponding to the set subject distance, by solving the created simultaneous equations. Then, the restoration unit 203 generates a restored image in which an image of a subject is formed, by arranging pixels having pixel values according to the calculated light intensity, in accordance with an arrangement of the individual point light sources on the subject surface 102.

In step S53, the imaging unit 41 performs various processes on the restored image. For example, the restoration unit 203 performs demosaic processing, gamma correction, white balance adjustment, conversion processing to a predetermined compression format, and the like on the restored image, if necessary. Furthermore, the restoration unit 203 supplies the obtained restored image to the camera ECU 42 via the communication unit 124.

Thereafter, the image restoration process ends.

As described above, by performing the hazardous object recognition process by using not only the wide angle-of-view restored image but also the narrow angle-of-view restored image, the recognition accuracy of the hazardous object is improved. As a result, it becomes possible to avoid hazardous objects more safely and appropriately.

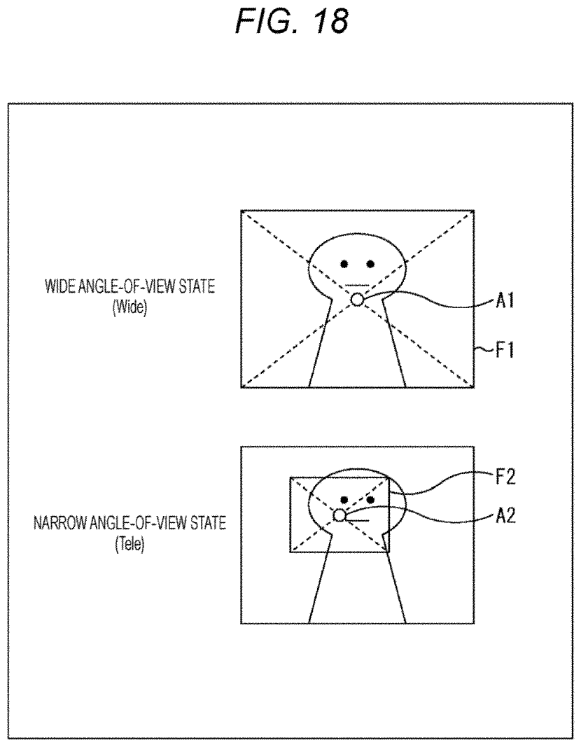

Furthermore, in a conventional camera of a zoom lens type, it is necessary to drive a zoom lens before capturing an image having a narrow angle of view after capturing an image having a wide angle of view, which takes time. Moreover, as schematically illustrated in FIG. 18, since there is a deviation between an optical axis A1 in a state of a wide angle of view F1 and an optical axis A2 in a state of a narrow angle of view F2, there is a risk of losing sight of a hazardous object by being unable to obtain an image having an appropriate angle of view.

Whereas, since it is not necessary to drive a zoom lens in the imaging unit 41, an image having an appropriate angle of view (the narrow angle-of-view restored image) can be obtained quickly and easily. Furthermore, in the imaging unit 41, there is almost no deviation of the optical axis between the wide angle-of-view restored image and the narrow angle-of-view restored image. Therefore, even if the image to be used is switched, the possibility of losing sight of the hazardous object is reduced.

### 2. Second Embodiment

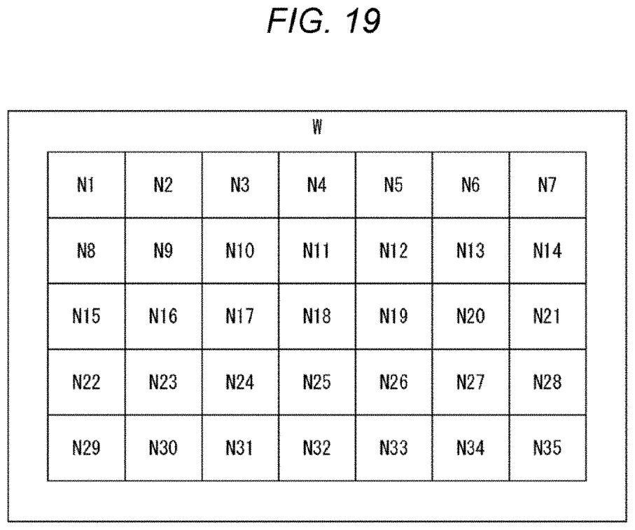

Next, a second embodiment of the present technology will be described with reference to FIGS. 19 to 25.

<Configuration Example of Pixel Array Unit of Imaging Element 121>

First, a configuration example of a pixel array unit of an imaging element 121 according to the second embodiment will be described with reference to FIGS. 19 to 24.

In the second embodiment, an angle of view of each pixel 121a of the imaging element 121 is further finely segmented as compared with the first embodiment.

FIG. 19 illustrates an example of an angle of view of the imaging element 121.

The imaging element 121 is provided with 36 types of pixels 121a corresponding to any of an angle of view W and the angles of view N1 to N35.

The angles of view N1 to N35 are angles of view obtained by segmenting an angle of view of a predetermined size into 35 equal parts of 7 columns vertically×5 rows horizontally. The angles of view N1 to N7 are arranged from left to right in the first line. The angles of view N8 to N14 are arranged from left to right in the second line. The angles of view N15 to N21 are arranged from left to right in the third line. The angles of view N22 to N28 are arranged from left to right in the fourth line. The angles of view N29 to N35 are arranged from left to right in the fifth line.

The angle of view W is wider than an angle of view obtained by combining the angles of view N1 to N35.

Note that, hereinafter, a pixel 121a having the angle of view W will be referred to as a wide angle-of-view pixel Pw, and pixels 121a having the angles of view N1 to N35 will be respectively referred to as narrow angle-of-view pixels Pn1 to Pn35. Hereinafter, a detection image including a detection signal outputted from each wide angle-of-view pixel Pw is referred to as a wide angle-of-view detection image IDw, and detection images including detection signals outputted from the narrow angle-of-view pixels Pn1 to Pn35 will be respectively referred to as narrow angle-of-view detection images IDn1 to IDn35. Hereinafter, a restored image restored from the wide angle-of-view detection image IDw will be referred to as a wide angle-of-view restored image IRw, and restored images restored from the narrow angle-of-view detection images IDn1 to IDn35 will be respectively referred to as narrow angle-of-view restored images IRn1 to IRn35.

Furthermore, hereinafter, in a case where it is not necessary to individually distinguish the angles of view N1 to N35, it is simply referred to as an angle of view N. Hereinafter, in a case where it is not necessary to individually distinguish the narrow angle-of-view pixels Pn1 to Pn35, they are simply referred to as a narrow angle-of-view pixel Pn. Hereinafter, in a case where it is not necessary to individually distinguish the narrow angle-of-view detection images IDn1 to IDn35, they are simply referred to as a narrow angle-of-view detection image IDn. Hereinafter, in a case where it is not necessary to individually distinguish the narrow angle-of-view restored images IRn1 to IRn35, they are simply referred to as a narrow angle-of-view restored image IRn.

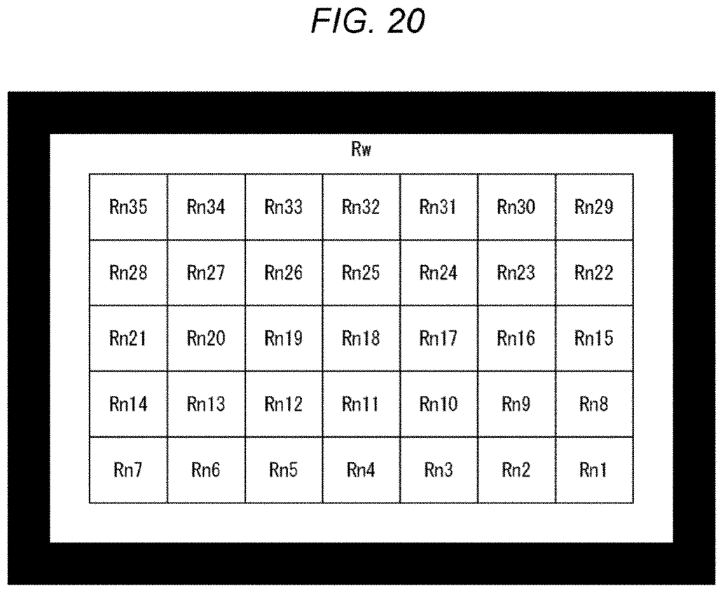

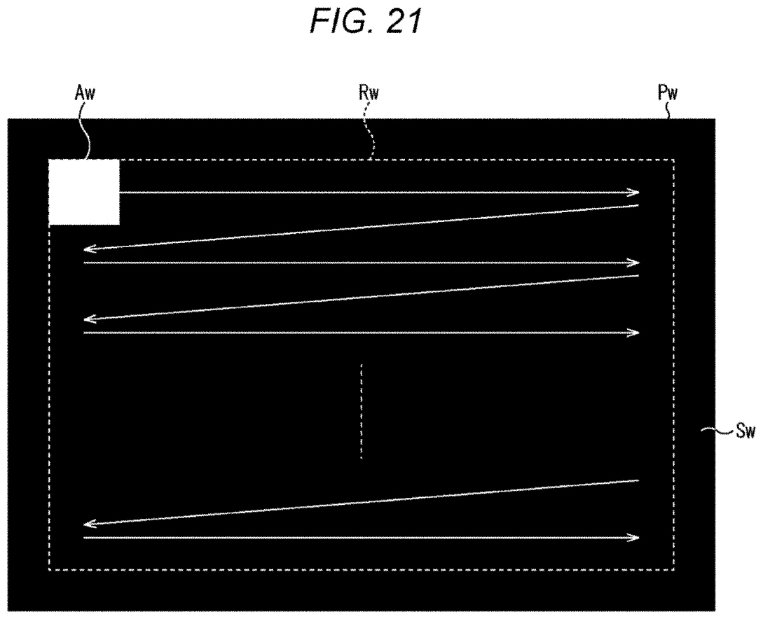

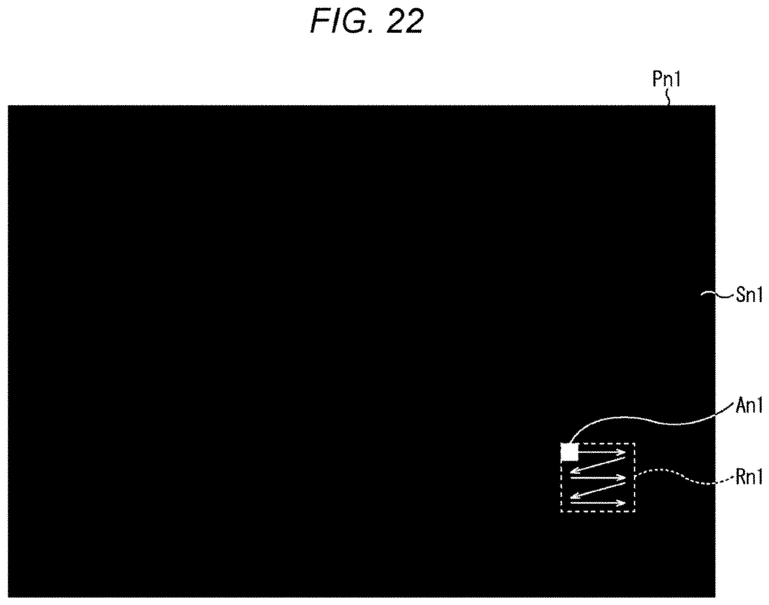

FIGS. 20 to 22 illustrate an embodiment of a light-shielding pattern of a pixel array unit of the imaging element 121. FIG. 20 illustrates an example of an opening setting range Rw and opening setting ranges Rn1 to Rn35 of the wide angle-of-view pixel Pw and the narrow angle-of-view pixels Pn1 to Pn35. FIG. 21 illustrates an example of a light-shielding pattern of the wide angle-of-view pixel Pw. FIG. 22 illustrates an example of a light-shielding pattern of the narrow angle-of-view pixel Pn1.

As illustrated in FIG. 20, the opening setting range Rw is wider than a region obtained by combining the opening setting ranges Rn1 to Rn35. Furthermore, an arrangement of the opening setting ranges Rn1 to Rn35 is point-symmetrical with respect to an arrangement of the corresponding angles of view N1 to N35 (FIG. 19). For example, the opening setting range Rn1 corresponding to the angle of view N1 in an upper left corner is arranged in a lower right corner of the pixel 121a, and the opening setting range Rn35 corresponding to the angle of view N35 in a lower right corner is arranged in an upper left corner of the pixel 121a.

As illustrated in FIG. 21, an opening Aw of a light-shielding film Sw of each wide angle-of-view pixel Pw is set within a rectangular opening setting range Rw shown by a dotted line. Therefore, a region other than the opening setting range Rw of the light-shielding film Sw of each wide angle-of-view pixel Pw is to be a main light-shielding part of the light-shielding film Sw.

A size, a shape, and a position of the opening setting range Rw are common to each wide angle-of-view pixel Pw. The opening setting range Rw occupies most of the wide angle-of-view pixel Pw. Furthermore, a barycenter of the opening setting range Rw substantially coincides with a center of the wide angle-of-view pixel Pw.

A shape and a size of the rectangular opening Aw are common to each wide angle-of-view pixel Pw. Furthermore, the opening Aw is arranged within the opening setting range Rw of each wide angle-of-view pixel Pw in accordance with a rule similar to the rule described above with reference to FIGS. 12 and 13.

For example, the opening Aw is arranged in an upper left corner in the opening setting range Rw in the wide angle-of-view pixel Pw arranged at a position closest to an upper left corner in the pixel array unit. Then, the opening Aw shifts in a right direction in the opening setting range Rw as the position of the wide angle-of-view pixel Pw advances to the right in the pixel array unit. The opening Aw shifts in a downward direction in the opening setting range Rw as the position of the wide angle-of-view pixel Pw advances downward in the pixel array unit. As a result, the opening setting range Rw is covered by the openings Aw of the individual wide angle-of-view pixels Pw. That is, a region where the openings Aw of individual wide angle-of-view pixels Pw are overlapped is to be equal to the opening setting range Rw.

Note that the arrangement pattern of the openings Aw is not limited to the above configuration, and any arrangement may be used as long as the region where the individual openings Aw are overlapped is equal to the opening setting range Rw. For example, in each wide angle-of-view pixel Pw, the openings Aw may be randomly arranged within the opening setting range Rw.

Here, a barycenter of incident angle directivity of the individual wide angle-of-view pixels Pw substantially coincides with a barycenter of the opening Aw of each wide angle-of-view pixel Pw. Therefore, an average of the barycenters of the incident angle directivity of the individual wide angle-of-view pixel Pw substantially coincides with a center of the wide angle-of-view pixel Pw. That is, an average of incident angles of barycenter light beams of the individual wide angle-of-view pixels Pw substantially coincides with a normal direction of a light-receiving surface of the pixel array unit.

As illustrated in FIG. 22, an opening An1 of a light-shielding film Sn1 of each narrow angle-of-view pixel Pn1 is set within a rectangular opening setting range Rn1 shown by a dotted line. Therefore, a region other than the opening setting range Rn1 of the light-shielding film Sn1 of each narrow angle-of-view pixel Pn1 is to be a main light-shielding part of the light-shielding film Sn1.

A size, a shape, and a position of the opening setting range Rn1 are common to each narrow angle-of-view pixel Pn1. The opening setting range Rn1 is very small as compared with the opening setting range Rw of the wide angle-of-view pixel Pw. Furthermore, the opening setting range Rn1 is biased diagonally downward to the right in the narrow angle-of-view pixel Pn1. Therefore, a barycenter of the opening setting range Rn1 is biased diagonally downward to the right from a center of the narrow angle-of-view pixel Pn1.

A shape and a size of the rectangular opening An1 are common to each narrow angle-of-view pixel Pn1. Furthermore, the opening An1 is arranged within the opening setting range Rn1 of each narrow angle-of-view pixel Pn1 in accordance with a rule similar to the rule described above with reference to FIGS. 12 and 13.

For example, the opening An1 is arranged in an upper left corner in the opening setting range Rn1 in the narrow angle-of-view pixel Pn1 arranged at a position closest to an upper left corner in the pixel array unit. Then, the opening An1 shifts in a right direction in the opening setting range Rn1 as the position of the narrow angle-of-view pixel Pn1 advances to the right in the pixel array unit. The opening An1 shifts in a downward direction in the opening setting range Rn1 as the position of the narrow angle-of-view pixel Pn1 advances downward in the pixel array unit. As a result, the opening setting range Rn1 is covered by the openings An1 of the individual narrow angle-of-view pixels Pn1. That is, a region where the openings An1 of individual narrow angle-of-view pixels Pn1 are overlapped is to be equal to the opening setting range Rn1.

Note that the arrangement pattern of the openings An1 is not limited to the above configuration, and any arrangement may be used as long as the region where the openings An1 of the individual narrow angle-of-view pixels Pn1 are overlapped is equal to the opening setting range Rn1. For example, the openings An1 may be randomly arranged within the opening setting range Rn1.

Here, a barycenter of incident angle directivity of the individual narrow angle-of-view pixels Pn1 substantially coincides with a barycenter of the openings An1 of the individual narrow angle-of-view pixels Pn1, and is biased diagonally downward to the right from a center of each narrow angle-of-view pixel Pn1. Therefore, an average of barycenters of the incident angle directivity of the individual narrow angle-of-view pixels Pn1 is biased diagonally downward to the right from a center of the narrow angle-of-view pixel Pn1. Furthermore, an average of incident angles of barycenter light beams of the individual narrow angle-of-view pixel Pn1 is inclined diagonally upward to the left with respect to a normal direction of the light-receiving surface of the pixel array unit. Therefore, each narrow angle-of-view pixel Pn1 enables imaging with the angle of view N1 of FIG. 19.

Note that, although illustration and detailed description are omitted, also in each narrow angle-of-view pixel Pni (i=2 to 35), an opening Ani (i=2-35) is set to cover an opening setting range Rni (i=2 to 35), similarly to each narrow angle-of-view pixel Pn1.

Note that, in a case where the number of wide angle-of-view pixels Pw and the number of the narrow angle-of-view pixels Pn1 to Pn35 are individually the same, the opening Aw of the wide angle-of-view pixel Pw is set to be larger than openings An1 to An35 of the narrow angle-of-view pixels Pn1 to Pn35. Furthermore, the openings An1 to An35 of the narrow angle-of-view pixels Pn1 to Pn35 are all set to the same size. Moreover, as described above, in a case where the numbers of wide angle-of-view pixels Pw and the narrow angle-of-view pixels Pn1 to Pn35 are individually the same, the narrow angle-of-view restored images IRn1 to IRn35 with a narrow angle of view have higher image quality (higher resolution) than that of the wide angle-of-view restored image IRw with a wide angle of view.

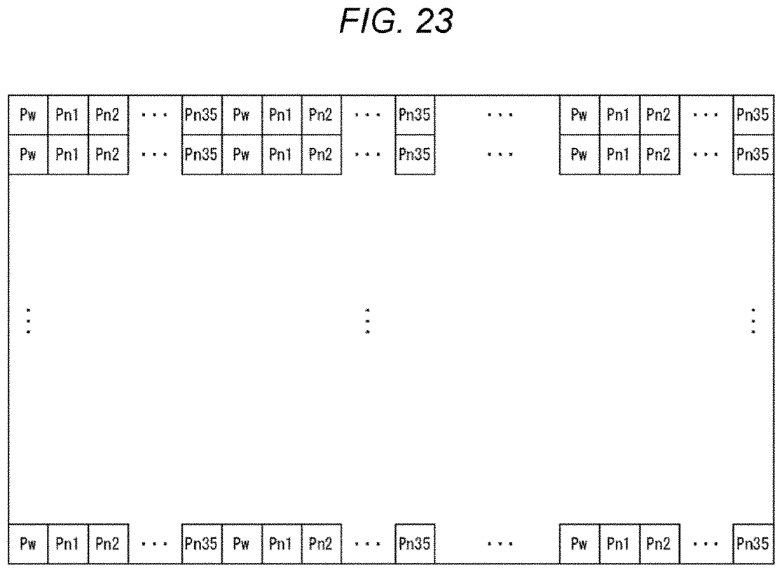

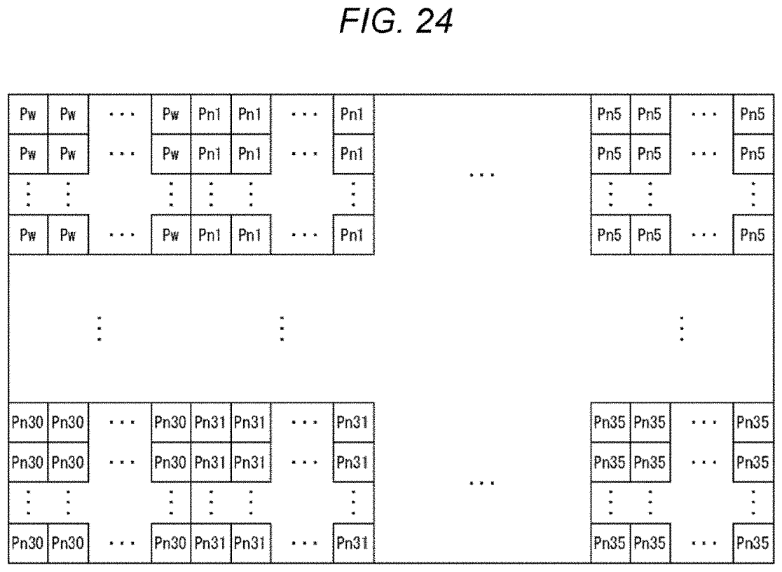

FIGS. 23 and 24 illustrate an arrangement example of the wide angle-of-view pixel Pw and the narrow angle-of-view pixels Pn1 to Pn35 in a case where the number of wide angle-of-view pixels Pw and the number of the narrow angle-of-view pixels Pn1 to Pn35 are individually the same.

In the example of FIG. 23, the wide angle-of-view pixel Pw and the narrow angle-of-view pixels Pn1 to Pn35 are periodically arranged at predetermined intervals. Specifically, the wide angle-of-view pixel Pw and the narrow angle-of-view pixels Pn1 to Pn35 are repeatedly arranged in a predetermined order in each row of the pixel array unit. The wide angle-of-view pixels Pw are arranged in 1+36j (j=0, 1, 2, . . . ) columns of the pixel array unit, and the narrow angle-of-view pixels Pni (i=1 to 35) are arranged in 1+i+36j columns in the pixel array unit.

In the example of FIG. 24, the wide angle-of-view pixel Pw and the narrow angle-of-view pixels Pn1 to Pn35 are individually collectively arranged. For example, in the pixel array unit, a region in which the wide angle-of-view pixels Pw are arranged two-dimensionally is arranged in an upper left corner, and a region in which the narrow angle-of-view pixels Pn1 are arranged two-dimensionally is arranged on the left. In this way, 36 regions in which the wide angle-of-view pixel Pw and the narrow angle-of-view pixels Pn1 to Pn35 are individually arranged two-dimensionally are arranged in 6 rows vertically×6 columns horizontally in the pixel array unit.

<Monitoring Process>

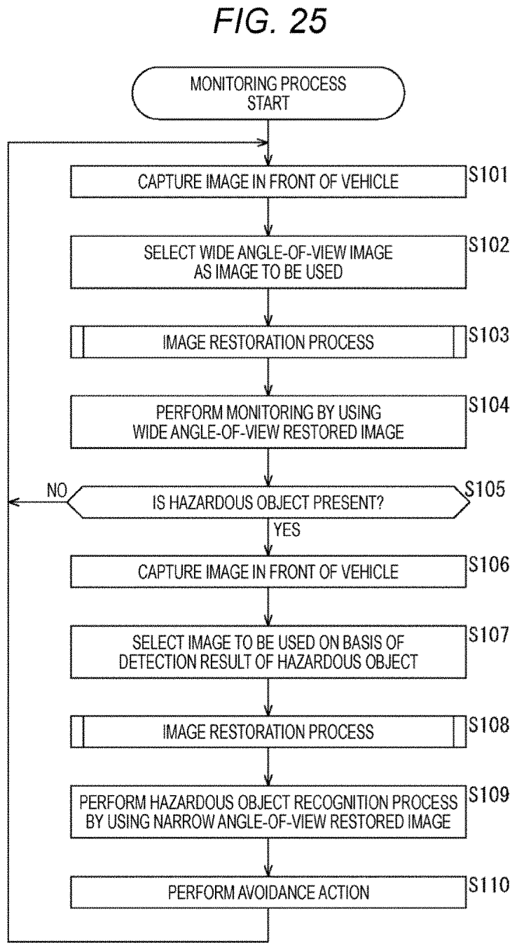

Next, a second embodiment of a monitoring process executed by an information processing system 11 will be described with reference to the flowchart of FIG. 25.

This process starts, for example, when power of the vehicle including the information processing system 11 is turned on, and ends when the power is turned off.

In step S101, the imaging element 121 captures an image of the front of the vehicle. As a result, the wide angle-of-view detection image IDw including a detection signal of the wide angle-of-view pixel Pw, and the narrow angle-of-view detection images IDn1 to IDn35 including detection signals of the narrow angle-of-view pixels Pn1 to Pn35 are obtained. The imaging element 121 supplies the wide angle-of-view detection image IDw and the narrow angle-of-view detection images IDn1 to IDn35 to a control unit 28 via a communication unit 124, a camera ECU 42, and a MCU 43.

In step S102, the pixel selection unit 202 selects a wide angle-of-view image as an image to be used. That is, the pixel selection unit 202 selects the wide angle-of-view restored image IRw restored from the wide angle-of-view detection image IDw, as the image to be used for monitoring the front of the vehicle. As a result, the wide angle-of-view pixel Pw is selected as a pixel of the imaging element 121 to be used for monitoring, and the wide angle-of-view detection image IDw including a detection signal outputted from each wide angle-of-view pixel Pw is selected as a restoration target for the process in step S103.

In step S103, the restoration unit 203 executes the image restoration process described above with reference to FIG. 17. As a result, the wide angle-of-view restored image IRw is restored from the wide angle-of-view detection image IDw.

In step S104, monitoring is performed by using the wide angle-of-view restored image IRw similarly to the process of step S4 of FIG. 16.

In step S105, similarly to the process of step S5 of FIG. 16, it is determined whether or not the hazardous object is present. In a case where it is determined that a hazardous object is not present, the process returns to step S101.

Thereafter, the processes of steps S101 to S105 are repeatedly executed until it is determined in step S105 that a hazardous object is present. That is, in a case where no hazardous object is detected, monitoring using the wide angle-of-view restored image IRw is repeatedly executed.

Whereas, in a case where it is determined in step S105 that a hazardous object is present, the process proceeds to step S106.

In step S106, an image in front of the vehicle is captured similarly to the process of step S101. As a result, the wide angle-of-view detection image IDw and the narrow angle-of-view detection images IDn1 to IDn35 are obtained.

In step S107, the pixel selection unit 202 selects an image to be used on the basis of a detection result of the hazardous object. For example, the pixel selection unit 202 selects the narrow angle-of-view restored image IRn to be used for monitoring on the basis of a position and a size of the hazardous object detected in the wide angle-of-view restored image IRw.

For example, in a case where only one hazardous object is detected, the pixel selection unit 202 selects the narrow angle-of-view restored image IRn in which an angle of view N overlaps with at least a part of a region where the hazardous object is present, in the wide angle-of-view restored image IRw.

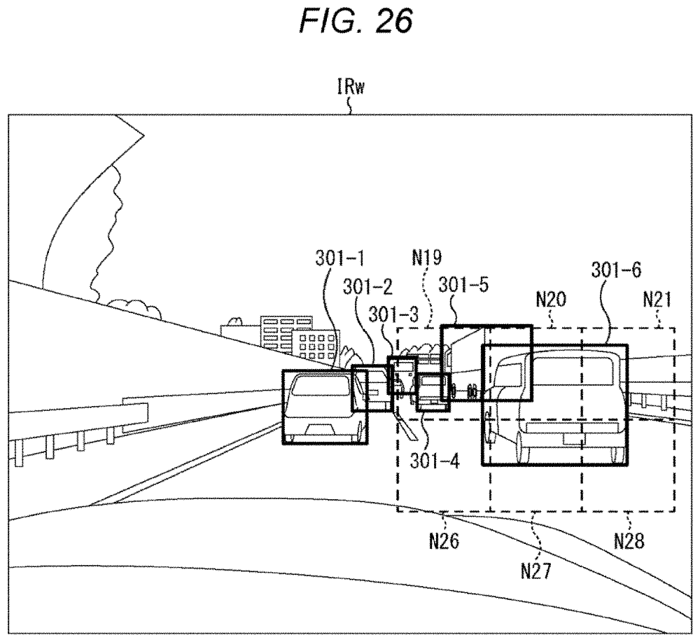

For example, in a case where a vehicle 301-6 is detected as a hazardous object among the vehicles 301-1 to 301-6 in front in the wide angle-of-view restored image IRw of FIG. 26, angles of view N19 to N21 and angles of view N26 to N28 include at least a part of the vehicle 301-6. In this case, narrow angle-of-view restored images IRn19 to IRn21 and narrow angle-of-view restored images IRn26 to IRn28 respectively corresponding to the angles of view N19 to N21 and the angles of view N26 to N28 are selected.

Furthermore, for example, in a case where a plurality of hazardous objects is detected, the pixel selection unit 202 may select the narrow angle-of-view restored image IRn to be used for monitoring on the basis of all the hazardous objects, or on the basis of some of the hazardous objects.

In the former case, for example, the pixel selection unit 202 selects a narrow angle-of-view restored image IRn in which the angle of view N overlaps with at least a part of a region where any hazardous object is present, in the wide angle-of-view restored image IRw.

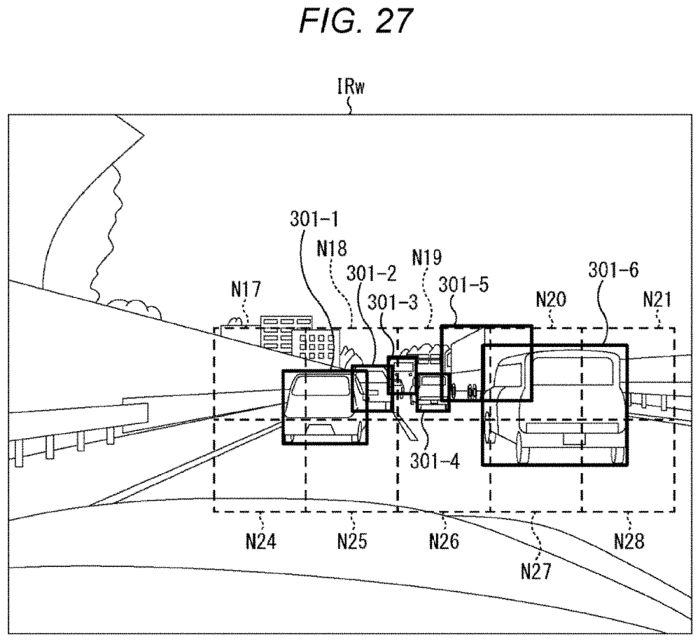

For example, in a case where the vehicle 301-1 and the vehicle 301-6 are detected as hazardous objects from among the vehicles 301-1 to 301-6 in front in the wide angle-of-view restored image IRw of FIG. 27, angles of view N17 to N21 and angles of view N24 to N28 include at least a part of at least one of the vehicle 301-1 or the vehicle 301-6. In this case, narrow angle-of-view restored images IRn17 to IRn21 and narrow angle-of-view restored images IRn24 to IRn28 respectively corresponding to the angles of view N17 to N21 and the angles of view N24 to N28 are selected.

In the latter case, for example, first, the pixel selection unit 202 sets a priority of each hazardous object on the basis of a predetermined condition.

For example, the priority is set on the basis of a distance to the vehicle. For example, the priority is set higher as the distance of the hazardous object to the vehicle is closer, and the priority is set lower as the distance of the hazardous object to the vehicle is farther.

For example, the priority is set on the basis of a size of the hazardous object in the wide angle-of-view restored image. For example, the priority is set higher as the hazardous object is larger, and the priority is set lower as the hazardous object is smaller.

For example, the priority is set on the basis of a type of hazardous object. For example, in a case where the hazardous object is a person, the priority is set higher than a case where the hazardous object is another object such as a vehicle.

Next, the pixel selection unit 202 selects one or more hazardous objects as monitoring targets on the basis of the priority. For example, the pixel selection unit 202 selects, as a monitoring target, a hazardous object having the highest priority, a predetermined number of hazardous objects having a higher priority, or a hazardous object having a priority equal to or higher than a threshold value.

Next, the pixel selection unit 202 selects a narrow angle-of-view restored image IRn in which the angle of view N overlaps with at least a part of a region where any of the hazardous objects selected as the monitoring target is present, in the wide angle-of-view restored image IRw.

As a result, as a pixel of the imaging element 121 to be used for monitoring, a narrow angle-of-view pixel Pn corresponding to the angle of view N overlapping at least a part of the region where any of the hazardous objects to be a monitoring target is present is selected. Furthermore, as a restoration target of the process in step S108, the narrow angle-of-view detection image IDn including a detection signal outputted from each of the selected narrow angle-of-view pixels Pn is selected.

In step S108, the restoration unit 203 executes the image restoration process described above with reference to FIG. 17. By this process, the narrow angle-of-view restored image IRn is restored from the narrow angle-of-view detection image IDn selected in the process of step S107.

In step S109, similarly to the process of step S9 of FIG. 16, the hazardous object recognition process is performed by using the narrow angle-of-view restored image IRn selected in the process of step S107.

In step S110, similarly to the process of step S10 of FIG. 16, an avoidance action is performed.

Thereafter, the process returns to step S101, and the processes of steps S101 to S110 are repeatedly executed.

As described above, in the second embodiment, an angle of view for imaging is further finely classified as compared with the first embodiment, so that an image having a more appropriate angle of view can be easily obtained. As a result, the recognition accuracy of the hazardous object is further improved, and it becomes possible to avoid the hazardous objects more safely and appropriately.

Note that each angle of view N is considerably narrower than the angle of view W. Therefore, even if the number of narrow angle-of-view pixels Pn individually corresponding to the individual angles of view N is smaller than the number of wide angle-of-view pixels Pw, image quality of each narrow angle-of-view restored image PRn can be made higher than that of a wide angle-of-view restored image PRw. In this way, by reducing the number of narrow angle-of-view pixels Pn individually corresponding to the individual angles of view N, the image restoration process in step S108 can be reduced.

### 3. Modified Example

Hereinafter, a modified example of the above-described embodiment of the present technology will be described.

<Modified Example of Related to Pixel Selection Method>

In the above description, an example has been shown in which the pixel selection unit 202 selects (a restored image based on a detection signal from) the pixel 121a to be used on the basis of a detection result of a hazardous object, but the pixels 121a to be used may be selected on the basis of other conditions.

For example, the pixel selection unit 202 may select the pixel 121a to be used on the basis of an object that requires monitoring other than the hazardous object, similarly to the case of the hazardous object. As the objects that require monitoring other than the hazardous object, for example, road signs, license plates, and the like are assumed.

Furthermore, for example, the pixel selection unit 202 may select the pixel 121a to be used on the basis of a situation around the vehicle.

For example, the pixel selection unit 202 selects the pixel 121a having a narrow angle of view in a situation where monitoring in the vicinity of the vehicle is necessary or distant monitoring is not so necessary. As the situations where monitoring in the vicinity of the vehicle is necessary, for example, a case of traveling in an urban area, a case of traveling near an intersection, a case where a traffic volume in a surrounding area is large, and the like are assumed. As the situation where distant monitoring is not so necessary, for example, a case where visibility is poor due to dark surroundings, fog, or the like to prevent distant visibility is assumed.

Whereas, for example, the pixel selection unit 202 selects the pixel 121a having a wide angle of view in a situation where monitoring in the vicinity of the vehicle is not so necessary or distant monitoring is necessary. As the situations where monitoring in the vicinity of the vehicle is not so necessary, or where distant monitoring is necessary, for example, a case of driving in suburbs, a case of driving on a highway or an expressway, a case where a traffic volume in a surrounding area is small, and the like are assumed.

Moreover, for example, the pixel 121a to be used may be selected on the basis of a speed of the vehicle. For example, as the speed of the vehicle is faster, the pixel selection unit 202 selects the pixel 121a having a wide angle of view because the need for distant monitoring becomes higher. Whereas, for example, as the speed of the vehicle is slower, the pixel selection unit 202 selects the pixel 121a having a narrow angle of view because the need for monitoring in the vicinity of the vehicle becomes higher.

Furthermore, for example, an example has been shown in which, in step S9 of the monitoring process of FIG. 16, a narrow angle-of-view restored image of a next frame of the wide angle-of-view restored image used in the process of step S4 is used. On the other hand, for example, the imaging process in step S6 may be omitted, and a narrow angle-of-view restored image of the same frame as the wide angle-of-view restored image may be used in step S9. As a result, it becomes possible to quickly execute a detailed recognition process of a hazardous object.

Similarly, for example, an example has been shown in which, in step S109 of the monitoring process of FIG. 25, a narrow angle-of-view restored image IRn of a next frame of the wide angle-of-view restored image IRw used in the process of step S104 is used. On the other hand, for example, the imaging process in step S106 may be omitted, and a narrow angle-of-view restored image IRn of the same frame as the wide angle-of-view restored image IRw may be used in step S109. As a result, it becomes possible to quickly execute a detailed recognition process of a hazardous object.

Furthermore, in the examples of FIGS. 26 and 27, an example has been shown in which the pixel 121a having an angle of view overlapping with the hazardous object is selected, but a pixel 121a having an angle of view around such a pixel 121a may be further selected. For example, a pixel Pa of an angle of view N around the angles of view N19 to N21 and the angles of view N26 to N28 of FIG. 26 may be further selected.

Conversely, a pixel 121a having an angle of view in which the region overlapping the hazardous object is small may be made not to be selected. For example, the angles of view N19 and N26 in FIG. 26 have a very small region overlapping with the vehicle 301-6 that is the hazardous object. Therefore, the narrow angle-of-view pixel Pn19 having the angle of view N19 and the narrow angle-of-view pixel Pn26 having the angle of view N26 may be made not to be selected.

<Modified Example Related to Imaging Element 121>

The size and the type of the angle of view of each pixel 121a of the imaging element 121 described above are an example and can be changed.

For example, in the above description, an example has been shown in which the imaging element 121 is provided with pixels having a two-step angle of view, that is, a pixel having a wide angle of view and a pixel having a narrow angle of view, but a pixel having an angle of view of three or more steps may be provided.

For example, in the example of FIG. 19, the angles of view N1 to N35 are all set to the same size, but they may be set to different sizes. For example, angle of views of a central and lower regions may be narrowed where there is a high probability of the presence of a hazardous object having a high risk of collision or contact with the vehicle. Conversely, for example, an angle of view may be widened in a region of an upper left corner and an upper right corner where there is a low probability of the presence of a hazardous object having a high risk of collision or contact with the vehicle.

Furthermore, in the above description, an example has been shown in which the imaging element 121 always outputs detection images of all the angles of view, but only detection images corresponding to restored images to be used for monitoring may be outputted. For example, the imaging element 121 may output only a detection signal of a pixel 121a having an angle of view selected by the pixel selection unit 202 under the control of the control unit 122. As a result, the processing of the imaging element 121 is reduced.

Moreover, for example, a drive unit configured to independently drive the pixels 121a of individual angles of view may be provided so that imaging by the pixels 121a of the individual angles of view can be performed simultaneously or individually. Then, for example, only the pixel 121a corresponding to the restored image to be used for monitoring may perform imaging. As a result, the processing of the imaging element 121 is reduced.

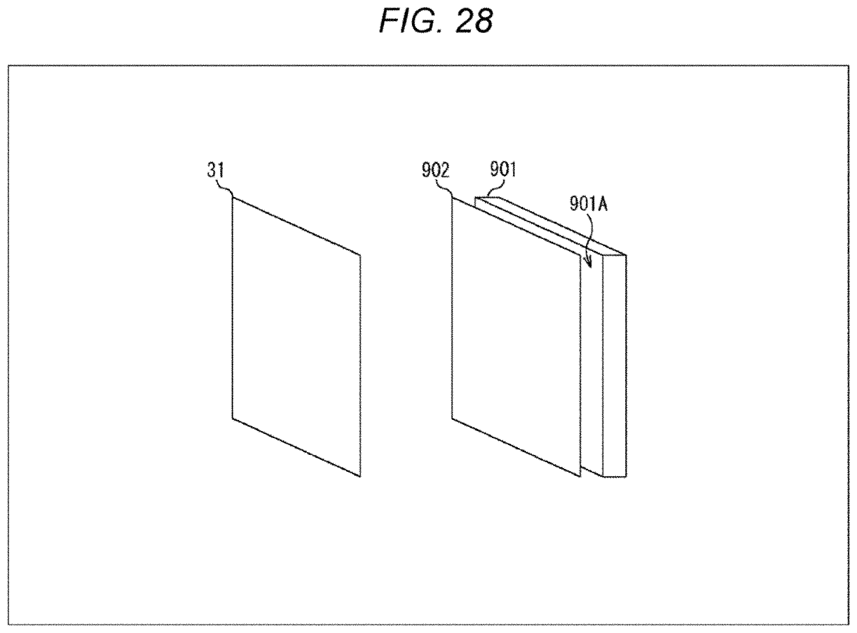

Furthermore, in FIG. 5, an example has been shown in which different incident angle directivity is given to each pixel by using the light-shielding film 121b as a modulation element or by changing a combination of photodiodes to contribute to output. However, in the present technology, for example, as illustrated in FIG. 28, it is also possible to use an optical filter 902 that covers a light-receiving surface of an imaging element 901 as a modulation element, to provide each pixel with incident angle directivity.

Specifically, the optical filter 902 is arranged so as to cover the entire surface of a light-receiving surface 901A at a predetermined distance from the light-receiving surface 901A of the imaging element 901. Light from a subject surface 102 is modulated by the optical filter 902 and then incident on the light-receiving surface 901A of the imaging element 901.

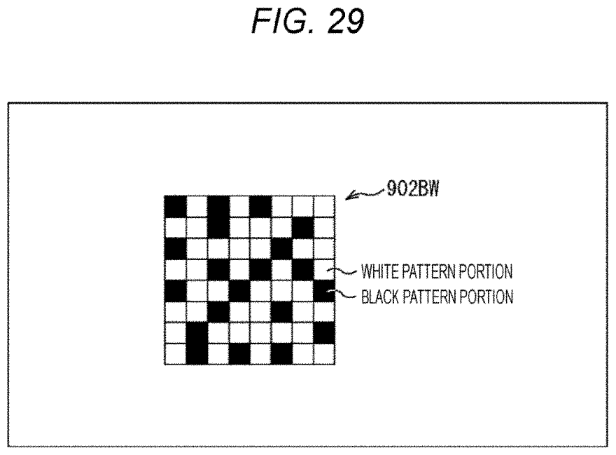

For example, as the optical filter 902, it is possible to use an optical filter 902BW having a black-and-white grid pattern illustrated in FIG. 29. In the optical filter 902BW, a white pattern portion that transmits light and a black pattern portion that shields light are randomly arranged. A size of each pattern is set independently of a size of the pixel of the imaging element 901.

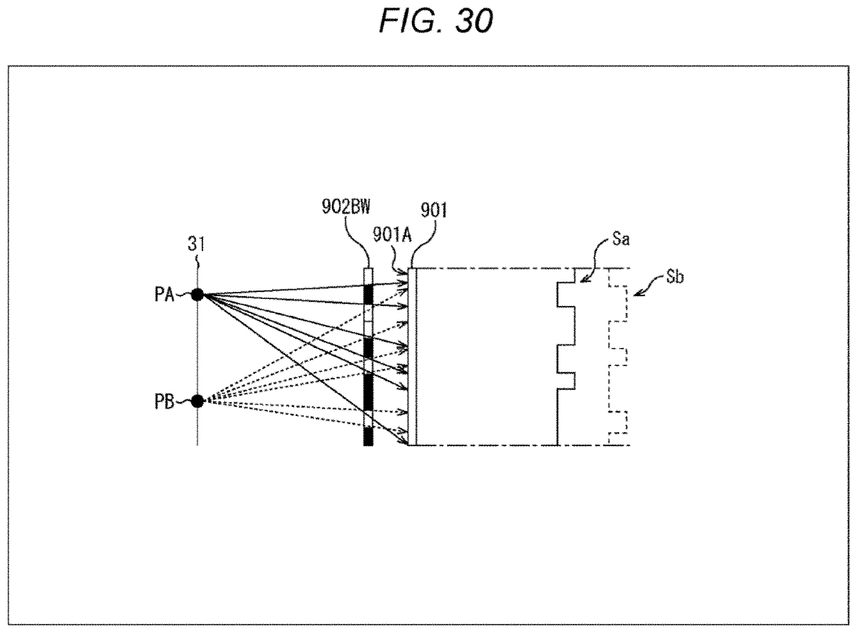

FIG. 30 illustrates light-receiving sensitivity characteristics of the imaging element 901 for light from point light sources PA and PB on the subject surface 102 in a case where the optical filter 902BW is used. The light from the point light sources PA and PB is individually modulated by the optical filter 902BW, and then incident on the light-receiving surface 901A of the imaging element 901.

For example, light-receiving sensitivity characteristics of the imaging element 901 with respect to the light from the point light source PA are to be as shown by a waveform Sa. That is, since shadows are generated by the black pattern portion of the optical filter 902BW, a shading pattern is generated in an image on the light-receiving surface 901A for the light from the point light source PA. Similarly, light-receiving sensitivity characteristics of the imaging element 901 for the light from the point light source PB are to be as shown by a waveform Sb. That is, since shadows are generated by the black pattern portion of the optical filter 902BW, a shading pattern is generated in an image on the light-receiving surface 901A for the light from the point light source PB.

Note that, since the light from the point light source PA and the light from the point light source PB have different incident angles on individual white pattern portions of the optical filter 902BW, the appearance of the shading pattern on the light-receiving surface is different. Therefore, each pixel of the imaging element 901 is to have incident angle directivity with respect to each point light source of the subject surface 102.

Details on this method are disclosed in, for example, “M. Salman Asif, 4 others, “Flatcam: Replacing lenses with masks and computation”, “2015 IEEE International Conference on Computer Vision Workshop (ICCVW)”, 2015, pp. 663-666.

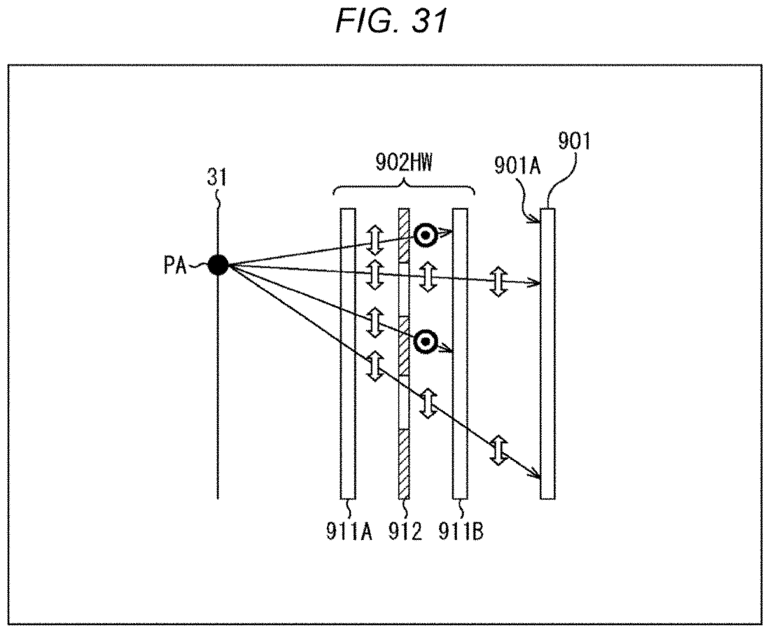

Note that an optical filter 902HW illustrated in FIG. 31 may be used instead of the black pattern portion of the optical filter 902BW. The optical filter 902HW includes a linear polarization element 911A and a linear polarization element 911B having equal polarization directions, and a ½ wavelength plate 912. The ½ wavelength plate 912 is interposed between the linear polarization element 911A and the linear polarization element 911B. The ½ wavelength plate 912 is provided with a polarization portion indicated by diagonal lines instead of the black pattern portion of the optical filter 902BW, and white pattern portions and the polarization portions are randomly arranged.

The linear polarization element 911A transmits only light in a predetermined polarization direction in almost unpolarized light emitted from the point light source PA. Hereinafter, it is assumed that the linear polarization element 911A transmits only light whose polarization direction is parallel to the figure. In the polarized light transmitted through the linear polarization element 911A, polarized light transmitted through the polarization portion of the ½ wavelength plate 912 changes in the polarization direction to a direction perpendicular to the figure due to rotation of a polarization plane. Whereas, in the polarized light transmitted through the linear polarization element 911A, polarized light transmitted through the white pattern portion of the ½ wavelength plate 912 does not change in the polarization direction and remains as it is in parallel to the figure. Then, the linear polarization element 911B transmits the polarized light transmitted through the white pattern portion and hardly transmits the polarized light transmitted through the polarization portion. Therefore, an amount of polarized light transmitted through the polarization portion is smaller than that of the polarized light transmitted through the white pattern portion. As a result, a shading pattern similar to that in a case where an optical filter BW is used is generated on the light-receiving surface 901A of the imaging element 901.

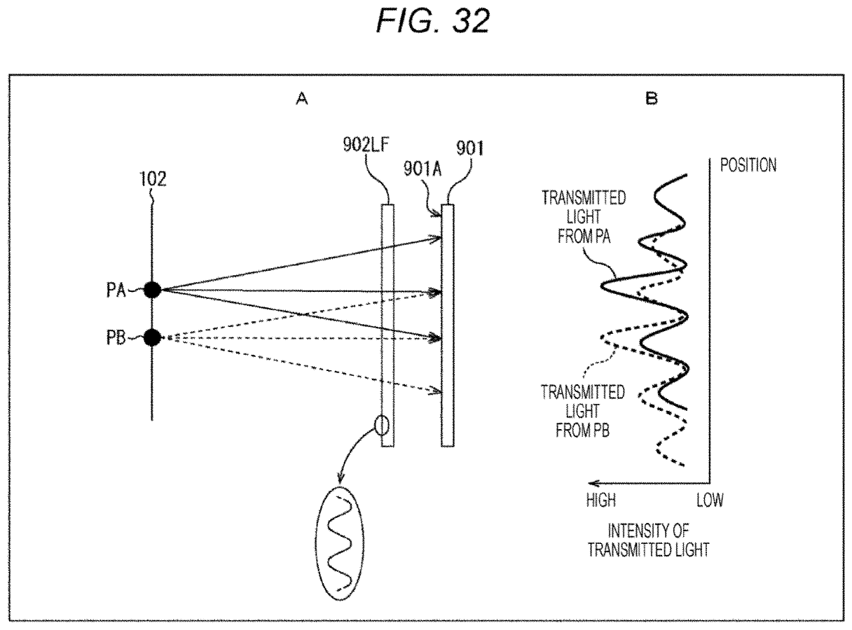

Furthermore, as illustrated in A of FIG. 32, an optical interference mask can be used as an optical filter 902LF. Light emitted from the point light sources PA and PB of the subject surface 102 is irradiated on the light-receiving surface 901A of the imaging element 901 via the optical filter 902LF. As illustrated in an enlarged view in a lower part of A of FIG. 32, for example, a light incident surface of the optical filter 902LF is provided with irregularities of a degree of a wavelength. Furthermore, in the optical filter 902LF, transmission of light of a specific wavelength irradiated from a perpendicular direction is maximized. When a change becomes large in an incident angle (an inclination with respect to the perpendicular direction) of light of a specific wavelength emitted from the point light sources PA and PB of the subject surface 102 with respect to the optical filter 902LF, an optical path length changes. Here, light weakens each other when the optical path length is an odd multiple of a half wavelength, and light strengthens each other when the optical path length is an even multiple of the half wavelength. That is, as illustrated in B of FIG. 32, an intensity of transmitted light of a specific wavelength emitted from the point light sources PA and PB and transmitted through the optical filter 902LF is modulated in accordance with an incident angle with respect to the optical filter 902LF, and incident on the light-receiving surface 901A of the imaging element 901. Therefore, a detection signal outputted from each pixel of the imaging element 901 is to be a signal obtained by synthesizing the modulated light intensity of each point light source for each pixel.

Details of this method are disclosed in, for example, Japanese Patent Application Laid-Open No. 2016-510910.

<Modified Example Related to Sharing of Processing in Information Processing System 11>

Sharing of processing in the information processing system 11 can be changed as appropriate.

For example, the processing of the recognition unit 23 can also be executed by the control unit 28, the imaging unit 41, or the camera ECU 42.

For example, the processing of the alert control unit 24 can also be executed by the recognition unit 23, the control unit 28, or the camera ECU 42.

For example, the processing of the hazardous object detection unit 201 can also be executed by the recognition unit 23, the imaging unit 41, or the camera ECU 42.

For example, the processing of the pixel selection unit 202 can also be executed by the imaging unit 41 or the camera ECU 42.

For example, the processing of the restoration unit 203 can also be executed by the imaging unit 41 or the camera ECU 42.

### Other Modified Examples

The present technology can also be applied to an imaging apparatus or an imaging element that images light having a wavelength other than visible light such as infrared light. In this case, a restored image is not to be an image in which the user can visually recognize the subject, but to be an image in which the user cannot visually recognize the subject. Also in this case, by using the present technology, the image quality of the restored image is improved with respect to an image processing apparatus or the like in which the subject can be recognized. Note that, since it is difficult for a normal imaging lens to transmit far-infrared light, the present technology is effective in a case of imaging far-infrared light, for example. Therefore, the restored image may be an image of far-infrared light, and may be an image of other visible light or non-visible light without limiting to far-infrared light.

Furthermore, for example, in a case where a hazardous object is detected and the object recognition process is performed using a narrow angle-of-view restored image, the narrow angle-of-view restored image may be displayed on the display unit 25 instead of a wide angle-of-view restored image. Furthermore, for example, an image in which the narrow angle-of-view restored image is superimposed on the wide angle-of-view restored image may be displayed on the display unit 25. As a result, the driver can see in more detail a region where the hazardous object is present.

Moreover, for example, the warning display may be controlled in accordance with control of operation of the vehicle by the operation control unit 27. For example, in a case where an avoidance operation is performed by the operation control unit 27, the warning display may be performed. As a result, it is possible to notify a passenger such as the driver of a reason why the avoidance operation is performed, and it is possible to give the passenger a sense of security.

Furthermore, for example, by applying machine learning such as deep learning, object recognition or the like can also be performed by using a detection image before restoration, without using a restored image after restoration. Also in this case, by using the present technology, the accuracy of image recognition using the detection image before restoration is improved. In other words, the image quality of the detection image before restoration is improved.

Moreover, in the above description, a case of monitoring the front of the vehicle has been taken as an example, but the present technology is also applicable to a case of monitoring in any direction (for example, rear, side, and the like) around the vehicle.

Furthermore, the present technology can also be applied to a case of monitoring surroundings of mobile objects other than vehicles. As such a mobile object, for example, a mobile object such as a motorcycle, a bicycle, a personal mobility, an airplane, a ship, a construction machine, an agricultural machine (tractor) and the like are assumed. Furthermore, mobile objects to which the present technology can be applied include, for example, a mobile object such as a drone or a robot that moves without a user boarding.

### 4. Other

The series of processes described above can be executed by hardware or also executed by software. In a case where the series of processes are performed by software, a program that configures the software is installed in a computer. Here, the computer includes a computer (for example, the control unit 122 or the like) incorporated in dedicated hardware, and the like.

A program executed by the computer can be provided by being recorded on, for example, a recording medium as a package medium or the like. Furthermore, the program can be provided via a wired or wireless transmission medium such as a local area network, the Internet, or digital satellite broadcasting.

Note that the program executed by the computer may be a program that performs processing in a time series according to an order described in this specification, or may be a program that performs processing in parallel or at necessary timing such as when a call is made.

Furthermore, the embodiments of the present technology are not limited to the above-described embodiments, and various modifications can be made without departing from the scope of the present technology.

For example, the present technology can have a cloud computing configuration in which one function is shared and processed in cooperation by a plurality of devices via a network.

Moreover, each step described in the above-described flowchart can be executed by one device, and also shared and executed by a plurality of devices.

Furthermore, in a case where one step includes a plurality of processes, the plurality of processes included in the one step can be executed by one device, and also shared and executed by a plurality of devices.

Note that the present technology can also have the following configurations.

(1)

An information processing apparatus including:

a pixel selection unit configured to select a pixel to be used from among pixels having a plurality of angles of view, on the basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and

a control unit configured to execute a predetermined process by using a selected pixel.

(2)

The information processing apparatus according to (1) described above, in which

the control unit includes:

a recognition unit configured to perform object recognition by using a detection image based on the detection signal of a selected pixel.

(3)

The information processing apparatus according to (2) described above, in which

the pixel selection unit selects a pixel to be used on the basis of a result of object recognition.

(4)

The information processing apparatus according to (3) described above, in which

the recognition unit performs object recognition by using a first detection image based on the detection signal of a pixel having a first angle of view, and

the pixel selection unit selects a pixel to be used on the basis of a result of object recognition using the first detection image.

(5)

The information processing apparatus according to (4) described above, in which

the pixel selection unit selects a pixel having a second angle of view that is narrower than the first angle of view, and

a resolution of a second detection image based on the detection signal of a pixel having the second angle of view is higher than a resolution of the first detection image.

(6)

The information processing apparatus according to any one of (3) to (5) described above, in which

the pixel selection unit selects a pixel to be used on the basis of a result of object recognition using the detection image of a previous frame.

(7)

The information processing apparatus according to any one of (3) to (6) described above, in which

the pixel selection unit selects a pixel to be used on the basis of one or more of recognized objects.

(8)

The information processing apparatus according to (7) described above, in which

the pixel selection unit selects a pixel whose angle of view overlaps with at least a part of the object.

(9)

The information processing apparatus according to (7) or (8) described above, in which

the pixel selection unit selects a pixel to be used on the basis of an object selected from recognized objects on the basis of a predetermined condition.

(10)

The information processing apparatus according to any one of (2) to (9) described above, in which

the control unit further includes:

a restoration unit configured to restore a restored image from the detection image, and

the recognition unit performs object recognition by using the restored image.

(11)

The information processing apparatus according to (10) described above, further including:

a display control unit configured to control displaying of the restored image.

(12)

The information processing apparatus according to (11) described above, in which

the display control unit further controls a warning display on the basis of a result of object recognition.

(13)

The information processing apparatus according to any one of (2) to (12) further including:

an operation control unit configured to control operation of a mobile object on the basis of a result of object recognition.

(14)

The information processing apparatus according to (13) described above, further including:

a display control unit configured to control a warning display in accordance with control of operation of the mobile object.

(15)

The information processing apparatus according to (13) or (14) described above, in which

the pixel selection unit selects a pixel to be used on the basis of at least one of a speed of the mobile object or a surrounding condition of the mobile object.

(16)

The information processing apparatus according to any one of (1) to (15) described above, in which

the control unit further includes:

an output control unit configured to control output of the detection signal of a selected pixel, from the imaging element.

(17)

An information processing method in which

an information processing apparatus performs processing including:

selecting a pixel to be used from among pixels having a plurality of angles of view, on the basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and

executing a predetermined process by using a selected pixel.

(18)

A program for causing a computer to perform processing including:

selecting a pixel to be used from among pixels having a plurality of angles of view, on the basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and

executing a predetermined process by using a selected pixel.

(19)

An information processing system including:

an imaging element including a plurality of pixels, the imaging element being configured to receive incident light incident from a subject without via either an imaging lens or a pinhole and to output a detection signal, the detection signal indicating an output pixel value that is modulated in accordance with an incident angle of the incident light and corresponding to any of a plurality of angles of view; and

an information processing apparatus, in which

the information processing apparatus includes:

a pixel selection unit configured to select a pixel to be used from among pixels having the plurality of angles of view on the basis of information obtained from the detection signal; and

a control unit configured to execute a predetermined process by using a selected pixel.

Note that the effects described in this specification are merely examples and are not limited, and other effects may be present.

### REFERENCE SIGNS LIST

11 Information processing system
21 Camera module
23 Recognition unit
24 Alert control unit
25 Display unit
26 Display control unit
27 Operation control unit
28 Control unit
41 Imaging unit
121 Imaging element
121a Pixel
122 Control unit
201 Hazardous object detection unit
202 Pixel selection unit
203 Restoration unit

1. An information processing apparatus comprising:
a pixel selection unit configured to select a pixel to be used from among pixels having a plurality of angles of view, on a basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and
a control unit configured to execute a predetermined process by using a selected pixel.

2. The information processing apparatus according to claim 1, wherein
the control unit includes:
a recognition unit configured to perform object recognition by using a detection image based on the detection signal of a selected pixel.

3. The information processing apparatus according to claim 2, wherein
the pixel selection unit selects a pixel to be used on a basis of a result of object recognition.

4. The information processing apparatus according to claim 3, wherein
the recognition unit performs object recognition by using a first detection image based on the detection signal of a pixel having a first angle of view, and
the pixel selection unit selects a pixel to be used on a basis of a result of object recognition using the first detection image.

5. The information processing apparatus according to claim 4, wherein
the pixel selection unit selects a pixel having a second angle of view that is narrower than the first angle of view, and
a resolution of a second detection image based on the detection signal of a pixel having the second angle of view is higher than a resolution of the first detection image.

6. The information processing apparatus according to claim 3, wherein
the pixel selection unit selects a pixel to be used on a basis of a result of object recognition using the detection image of a previous frame.

7. The information processing apparatus according to claim 3, wherein
the pixel selection unit selects a pixel to be used on a basis of one or more of recognized objects.

8. The information processing apparatus according to claim 7, wherein
the pixel selection unit selects a pixel whose angle of view overlaps with at least a part of the object.

9. The information processing apparatus according to claim 7, wherein
the pixel selection unit selects a pixel to be used on a basis of an object selected from recognized objects on a basis of a predetermined condition.

10. The information processing apparatus according to claim 2, wherein
the control unit further includes:
a restoration unit configured to restore a restored image from the detection image, and
the recognition unit performs object recognition by using the restored image.

11. The information processing apparatus according to claim 10, further comprising:
a display control unit configured to control displaying of the restored image.

12. The information processing apparatus according to claim 11, wherein
the display control unit further controls a warning display on a basis of a result of object recognition.

13. The information processing apparatus according to claim 2, further comprising:
an operation control unit configured to control operation of a mobile object on a basis of a result of object recognition.

14. The information processing apparatus according to claim 13, further comprising:
a display control unit configured to control a warning display in accordance with control of operation of the mobile object.

15. The information processing apparatus according to claim 13, wherein
the pixel selection unit selects a pixel to be used on a basis of at least one of a speed of the mobile object or a surrounding condition of the mobile object.

16. The information processing apparatus according to claim 1, wherein
the control unit includes:
an output control unit configured to control output of the detection signal of a selected pixel, from the imaging element.

17. An information processing method wherein
an information processing apparatus performs processing comprising:
selecting a pixel to be used from among pixels having a plurality of angles of view, on a basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and
executing a predetermined process by using a selected pixel.

18. A program for causing a computer to perform processing comprising:
selecting a pixel to be used from among pixels having a plurality of angles of view, on a basis of information obtained from a detection signal of an imaging element including a plurality of pixels, the imaging element being configured to receive incident light incident from a subject without via either an imaging lens or a pinhole and to output the detection signal, the detection signal indicating an output pixel value that is modulated in accordance with an incident angle of the incident light and corresponding to any of the plurality of angles of view; and
executing a predetermined process by using a selected pixel.

19. An information processing system comprising:
an imaging element including a plurality of pixels, the imaging element being configured to receive incident light incident from a subject without via either an imaging lens or a pinhole and to output a detection signal, the detection signal indicating an output pixel value that is modulated in accordance with an incident angle of the incident light and corresponding to any of a plurality of angles of view; and
an information processing apparatus, wherein
the information processing apparatus includes:
a pixel selection unit configured to select a pixel to be used from among pixels having the plurality of angles of view on a basis of information obtained from the detection signal; and
a control unit configured to execute a predetermined process by using a selected pixel.
